(19) United States
(12) Patent Application Publication
(10) Pub. No.: US 2026/0070221 A1
(43) Pub. Date: Mar. 12, 2026

(54) BIPEDAL ACTION MODEL FOR HUMANOID ROBOT

(71) Applicant: Figure AI Inc., San Jose, CA (US)

(72) Inventors: Corey Lynch, San Jose, CA (US); Toki Migimatsu, San Jose, CA (US); Michael Ahn, San Jose, CA (US)

(21) Appl. No.: 19/325,486

(22) Filed: Sep. 10, 2025

Related U.S. Application Data
(60) Provisional application No. 63/692,747, filed on Sep. 10, 2024.
(60) Provisional application No. 63/696,507, filed on Sep. 19, 2024.
(60) Provisional application No. 63/696,533, filed on Sep. 19, 2024.
(60) Provisional application No. 63/703,454, filed on Oct. 4, 2024.
(60) Provisional application No. 63/705,791, filed on Oct. 10, 2024.
(60) Provisional application No. 63/715,270, filed on Nov. 1, 2024.
(60) Provisional application No. 63/722,057, filed on Nov. 18, 2024.
(60) Provisional application No. 63/725,279, filed on Nov. 26, 2024.
(60) Provisional application No. 63/760,617, filed on Feb. 19, 2025.
(60) Provisional application No. 63/776,429, filed on Mar. 24, 2025.
(60) Provisional application No. 63/819,533, filed on Jun. 6, 2025.

(51) Int. Cl. B25J 9/16

(52) U.S. Cl. CPC B25J 9/1664; B25J 9/161; B25J 9/1697

(57) ABSTRACT

The present disclosure provides a system for generating motor control commands for a humanoid robot, comprising an alpha model with over 1 billion parameters that processes visual observations and language instructions at a first frequency to generate contextual embeddings, and a beta model operating at a higher second frequency. The beta model includes an embodiment-specific state encoder projecting robot state information into a shared embedding space, a diffusion transformer module generating denoised action sequences through iterative flow-matching that cross-attends to the alpha model's contextual embeddings, and an embodiment-specific action decoder converting denoised sequences into motor control commands. The beta model generates action chunks comprising future action sequences over a predetermined time horizon in a single inference step, with the complete system having less than 5 billion parameters.

### CROSS-REFERENCE TO RELATED APPLICATIONS

This application claims the benefit of and priority to U.S. Provisional Patent Application Nos. 63/692,747, 63/760,617, 63/819,533, 63/703,454, 63/696,507, 63/705,791, 63/725,279, 63/776,429, 63/715,270, 63/722,057, and 63/696,533, each of which is fully incorporated herein by reference.

### TECHNICAL FIELD

This disclosure relates to system design and architectures, methods and techniques for training and using a bipedal action model (BAM) to control a humanoid robot. The humanoid includes a plurality of hardware and software components that are configured to provide said robot with the ability to substantially mimic the movements, functionality, and capabilities of a human.

### BACKGROUND

The field of robotics has long pursued the goal of creating humanoid robots capable of performing complex tasks in unstructured, human-centric environments. A significant challenge in this pursuit is the development of control systems that can manage the vast number of degrees of freedom (DoF) inherent in a humanoid form. Conventional robotic control systems have traditionally been limited in their scope and capability. Many existing models are narrowly focused, designed to control only a specific part of the robot, such as a 7-DoF end-effector or arm. This approach effectively treats the robot as a disembodied limb, failing to coordinate the entire body. As a result, such systems cannot perform actions that require dynamic balance, postural adjustments, or the use of the torso and legs to extend reach and navigate obstacles. The movements produced are often rigid and limited to a constrained set of pre-programmed motions.

Furthermore, a common deficiency in conventional systems is their reliance on generating discrete, or “binned,” action outputs. This method breaks down continuous motion into a finite set of poses or commands. The result is often jerky, imprecise, and unnatural movement, akin to a video with a low frame rate. This discretization introduces compounding errors over time, causing the robot to deviate from its intended path and struggle with tasks requiring fluid, continuous adjustments. These systems lack the temporal consistency needed for smooth, long-horizon tasks and are not robust enough to adapt to the unpredictable nature of real-world environments.

Therefore, a significant need exists for a more advanced control architecture that can overcome these fundamental limitations. There is a demand for a system that can provide comprehensive, whole-body control over a high-degree-of-freedom humanoid robot and generate continuous, real-time control outputs to produce fluid, human-like motion, thereby enabling more effective and reliable performance in complex, dynamic settings.

### SUMMARY

The presently disclosed subject matter is directed to a system for generating motor control commands for a humanoid robot. Particularly, the system comprises an alpha model configured to process visual observations and language instructions at a first operational frequency to generate contextual embeddings, wherein the alpha model comprises a vision-language model more than 1 billion parameters. The system comprises a beta model operating at a second operational frequency higher than the first operational frequency, the beta model comprising an embodiment-specific state encoder configured to project robot state information into a shared embedding space. The beta model comprises a diffusion transformer module configured to generate denoised action sequences through iterative flow-matching, wherein the diffusion transformer module cross-attends to the contextual embeddings from the vision-language processing module. The beta model comprises an embodiment-specific action decoder configured to convert the denoised action sequences into motor control commands. The beta model generates action chunks comprising a sequence of future actions extending over a predetermined time horizon in a single inference step, and the system has less than 5 billion parameters.

The presently disclosed subject matter is directed to a vision-language-action (VLA) system for controlling a robot. Particularly, the system comprises a first neural network model having between 100 million and 10 billion parameters, wherein the first neural network model comprises a vision-language model (VLM) backbone configured to process multimodal inputs including visual data and natural language instructions. The system comprises a second neural network model having between 10 million and 1 billion parameters, wherein the second neural network model comprises an action decoder configured to generate continuous control outputs. The first neural network model operates at a frequency between 1 Hz and 100 Hz and generates intermediate representations that are processed by the second neural network model operating at a frequency between 50 Hz and 500 kHz to produce action chunks comprising continuous floating-point values for robot control.

The presently disclosed subject matter is directed to a method for training a bipedal action model for humanoid robot control. Particularly, the method comprises obtaining training data from a hierarchical data structure comprising a base layer containing internet-scale visual and textual data. The hierarchical data structure comprises a middle layer containing simulation-generated trajectories and synthetic neural trajectories. The hierarchical data structure comprises a top layer containing real-world robot teleoperation data. The method comprises training a vision-language model component to process multimodal inputs and generate semantic embeddings. The method comprises training an action generation component to produce continuous motor commands through flow-matching objectives, wherein the action generation component conditions on the semantic embeddings. The method comprises jointly optimizing the vision-language model component and the action generation component end-to-end to minimize a combined loss function comprising action prediction loss and auxiliary task losses.

The presently disclosed subject matter is directed to a vision-language-action (VLA) system. Particularly, the system comprises a vision-language backbone configured to encode interleaved image frames and natural-language instructions into token embeddings. The system comprises an action module configured to generate continuous robot actions conditioned on the token embeddings. Each image frame is encoded at and pixel-shuffled to produce 64 image token embeddings per frame, and the action module conditions on middle-layer embeddings from the backbone rather than final-layer embeddings.

The presently disclosed subject matter is directed to a distributed VLA system. Particularly, the system comprises a cloud-hosted, distilled VLA backbone. The system comprises a local action decoder executing on a robot. The backbone exhibits less than 250 ms query-to-response latency, a combined observation-to-action latency of about 400 ms, and emits multi-step action chunks yielding an effective control rate of about 50 Hz.

The presently disclosed subject matter is directed to a method for robot control. Particularly, the method comprises encoding images into 64 tokens per frame and interleaving the tokens with text tokens. The method comprises extracting middle-layer embeddings from a 12th transformer layer. The method comprises conditioning a diffusion transformer that alternates self- and cross-attention to generate H is less than 50 action chunks via a flow-matching steps timestep schedule and forward-Euler updates.

The presently disclosed subject matter is directed to a method for distributed VLA inference. Particularly, the method comprises distilling a VLA backbone and deploying the backbone in the cloud with less than 200 ms query-to-response latency. The method comprises deploying a local action decoder on-robot. The method comprises producing action chunks that yield an effective control rate of about 50 Hz with about 500 ms end-to-end latency.

The presently disclosed subject matter is directed to a non-transitory computer-readable medium storing instructions that, when executed by one or more processors, cause the processors to perform the method of encoding images into 64 tokens per frame and interleaving the tokens with text tokens, extracting middle-layer embeddings from a 12th transformer layer, and conditioning a diffusion transformer that alternates self- and cross-attention to generate H=16 action chunks via a flow-matching steps with a timestep schedule and forward-Euler updates.

The presently disclosed subject matter is directed to a non-transitory computer-readable medium storing instructions that, when executed by one or more processors, cause the processors to perform the method of distilling a VLA backbone and deploying the backbone in the cloud with less than 220 ms query-to-response latency, deploying a local action decoder on-robot, and producing action chunks that yield an effective control rate of about 50 Hz with about 325 ms end-to-end latency, or the method of encoding observations, caching keys and values for observation tokens across flow-matching steps, and performing 10 flow-matching steps over noised action tokens to predict H is less than 100 actions that are executed open-loop without temporal ensembling.

In various embodiments, the robotic control system may implement different architectural configurations for hierarchical neural network control. In some embodiments, a first neural network model may operate at frequencies between 1 Hz and 100 Hz, alternatively between 2-20 Hz, or specifically at approximately 10 Hz for high-level reasoning tasks. Alternative embodiments may configure this first model to process visual observations as video streams at 10-60 frames per second, with multimodal inputs comprising vision tokens, language tokens, and proprioceptive state features having total embedding dimensions ranging from 512 to 4096. The first model architecture may optionally comprise a decoder-only transformer, a vision transformer (ViT), or a multimodal transformer having at least 12 transformer blocks, with certain embodiments implementing less than 4 billion parameters in the vision-language component.

In alternative embodiments, a second neural network model may operate at higher frequencies ranging from 100 Hz to 500 kHz, with some implementations operating between 100-300 Hz for closed-loop motor control. Various embodiments may implement different coupling mechanisms between the models, including latent vector connections having between 128 and 2048 dimensions, or multi-scale feature extraction from intermediate layers such as a transformer layer of the backbone. Some embodiments may implement the second model as a diffusion transformer (DiT) performing between 2 and 50 denoising iterations per inference step. Different embodiments may generate action chunks of varying sizes, ranging from chunks comprising 16-50 actions, spanning temporal horizons between 10 milliseconds and 10 seconds, or specifically sized to span 50-500 milliseconds, with continuous values for anywhere between 5 and 62 degrees of freedom.

Various deployment configurations may be implemented across different embodiments. Some embodiments may deploy the first neural network model on cloud-based servers while deploying the second model on local processors integrated with the robot. Alternative embodiments may implement different training methodologies, including Low-Rank Adaptation (LoRA) with rank decomposition of at most 128 to reduce trainable parameters by at least 90%, synthetic neural trajectory generation from fine-tuned video generation models, domain randomization for sim-to-real transfer, or incorporation of corrective demonstrations from failure states. Certain embodiments may employ temporal ensembling by averaging overlapping action predictions, while others may execute action chunks open-loop without temporal ensembling. Some implementations may include validation of generated actions against kinematic constraints and collision boundaries, incorporation of whole-body controllers for translating motor commands to actuator signals, or auxiliary task losses comprising object detection for spatial grounding. The combined system across various embodiments may comprise total parameter counts ranging from 200 million to 11 billion parameters.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIG. 2-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a block diagram of a movement controller for the humanoid robot of FIGS. 1-3B;

FIG. 7 is a block diagram of a behavior manager for the humanoid robot of FIGS. 1-3B;

FIG. 8 is a block diagram of an onboard artificial intelligence (AI) system for the humanoid robot of FIGS. 1-3B;

FIG. 9 a diagram depicting an interaction of components contained within a computing architecture of the humanoid robot of FIGS. 1-3B;

FIG. 10 is a block diagram of a first hierarchical architecture of a BAM for use with the humanoid robot of FIGS. 1-3B;

FIG. 11 is a block diagram of a second hierarchical architecture of a BAM for use with the humanoid robot of FIGS. 1-3B;

FIG. 12 is a block diagram of a third hierarchical architecture of a BAM for use with the humanoid robot of FIGS. 1-3B;

FIG. 13 is a block diagram of a fourth hierarchical architecture of a BAM for use with the humanoid robot of FIGS. 1-3B;

FIG. 14A is a block diagram of a first example hierarchical architecture of a BAM;

FIG. 14B is a diagram depicting an example deployment configuration of the first example hierarchical architecture of FIG. 14A;

FIG. 15A is a block diagram of a second example hierarchical architecture of a BAM;

FIG. 15B is a diagram depicting example deployment configurations of the second example hierarchical architecture of FIG. 15A;

FIG. 16A is a block diagram of a third example hierarchical architecture of a BAM;

FIGS. 16B-16D are diagrams depicting example deployment configurations of the third example hierarchical architecture of FIG. 16A;

FIG. 17 is a block diagram of a fourth example hierarchical architecture of a BAM;

FIG. 18 is a block diagram of a fifth example hierarchical architecture of a BAM;

FIG. 19 is a flowchart illustrating a process of generating an BAM;

FIGS. 20-21 are flowcharts illustrating a process of using the BAM to output robot actions; and

FIG. 22 is a diagram depicting an interaction of components contained within a layered embodiment AI model of the humanoid robot of FIGS. 1-3B.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

Disclosed herein is a bipedal action model (BAM) architecture characterized by a decoupled dual-system design, comprising a high-level cognitive alpha model and a low-level reactive motor beta model. The alpha model, which may be a large, pretrained vision-language model with billions of parameters, is responsible for perception, language understanding, and long-horizon planning. It operates at a low frequency to process complex multimodal inputs, such as a user command like “get me a drink from the fridge,” and generates a task-conditioning latent vector that encapsulates the semantic goal of the task. This latent vector is then passed to the beta model, a smaller, high-frequency visuomotor policy with millions of parameters, which translates the high-level intent from alpha model into precise, continuous robot actions. This separation of concerns allows for independent development and optimization of the reasoning and control components, enabling the robot to benefit from the broad world knowledge of large models while maintaining the real-time responsiveness required for fluid and safe physical interaction in dynamic environments.

The placement of the alpha and beta models offers a range of deployment configurations to balance computational resources, latency, and autonomy. A fully local deployment, with both models running on the bipedal robot or humanoid robot's onboard hardware, minimizes communication latency and enables network-independent operation, which is suitable for tasks in environments with unreliable connectivity, but places a high demand on the robot's computational resources. The BAM's model architecture is highly configurable, allowing for different combinations of single and multiple models for the alpha and beta models to be employed. A system may be composed of a first pool that contains a single alpha model and a second pool that contains a single beta model. Meanwhile. the training of a BAM relies on a layered data structure that is designed to provide the model with a broad understanding of the world while grounding it in the specifics of robotic embodiment. The foundational layer consists of vast quantities of internet-scale text, images, and videos, supplemented by human demonstration data collected through robot-free methods like VR/AR systems, which provides a broad base of common-sense knowledge. The middle layer is composed of simulation and synthetic data, which provides a scalable way to generate millions of task-specific training examples in a controlled environment. The top layer contains the highest-fidelity real-world robot data, collected through teleoperation, which is essential for fine-tuning the model, bridging the sim-to-real gap, and ensuring its actions are physically plausible and effective.

The training process for a BAM can be adapted to its specific architecture, such as an beta model-only or a combined alpha/beta model, and can be based on imitation learning or other types of learning. The process can involve preparing a comprehensive, multimodal training dataset, which is then used to train the selected model configuration. For an beta model-only, the training focuses on learning a direct mapping from visual and state inputs to actions, making it highly proficient at a specific task. The co-trained of the combined alpha/beta model can be an end-to-end process, where the error between the beta model's predicted action and a ground-truth demonstration are backpropagated through both models. This allows the high-level alpha model to be fine-tuned and its general knowledge to be grounded in the physical actions of the beta model, leading to a more robust and generalizable policy.

The deployment of a trained BAM can involve a continuous, closed-loop process of perception, planning, and action. During runtime, the deployed model receives a stream of multimodal inputs, including user commands and real-time sensor and state data from the robot. This data is ingested by the BAM, which outputs a sequence of action chunks representing the desired future trajectory of the robot. These high-level actions can then translated into low-level motor commands by a whole body controller, which also performs a series of safety checks to ensure the commands are kinematically feasible and collision-free before executing them on the robot's actuators. The robot's new state is then fed back into the BAM, allowing for a continuous cycle of action generation that enables the robot to perform long-horizon tasks and dynamically adapt to its environment.

The disclosed BAM integrates artificial intelligence models into a tangible system that solves significant, long-standing technological problems in robotic control. The disclosed BAM is not merely an instruction to “apply” an abstract idea on a generic computer; rather, it is a particular technological solution to a deeply rooted technological problem. A primary technical improvement offered by the BAM is its revolutionary approach to whole-body, continuous control. Conventional robotic systems are fundamentally limited, often confined to controlling a 7-degree-of-freedom (DoF) end-effector with discrete, binned-value outputs, which results in movements that are characteristically clunky, stilted, and imprecise. The disclosed BAM architecture overcomes this critical deficiency by providing direct, continuous control over the full sixty-two degrees of freedom of the bipedal or humanoid robot. This is not a mere improvement in processing speed but a fundamental paradigm shift in robotic control, enabling highly coordinated, human-like motions that leverage the robot's entire physical structure for dynamic balance, extended reach, and sophisticated obstacle negotiation. This constitutes a specific, tangible improvement to the functioning and capability of the robot itself, far exceeding the abstract idea of robotic control.

Action chunking can be used for the BAM output, where the alpha model predicts a sequence of multiple future actions in a single inference step. This approach offers several advantages, including the mitigation of compounding errors in imitation learning, the ability to handle non-Markovian behaviors in demonstration data, and the decoupling of the model's low inference frequency from the robot's high control frequency, which can be helpful in achieving smooth, human-like motion. Various action chunking strategies can be employed, from simple sequential execution, which is easy to implement but may lead to jerky movements, to more advanced asynchronous methods like real-time chunking and temporal ensemble, which are designed to improve motion smoothness and reactivity by overlapping the prediction and execution of action chunks.

Furthermore, the BAM provides a particular solution to the well-known technical problem of compounding errors in imitation learning through its use of “action chunking.” By predicting and executing a sequence of future actions in a single inference step, the BAM architecture specifically mitigates the accumulation of small prediction errors that cause prior art systems to deviate from desired trajectories. This technique provides a concrete solution that improves the temporal consistency and reliability of the robot's movements. This is combined with a specific and versatile internal architecture, such as the hierarchically arranged alpha and beta models with defined local, remote, or split deployment configurations, which solves the technical challenge of achieving real-time, context-aware decision-making without the debilitating latency that plagues remote-only systems. The invention is therefore not directed to the mere idea of a solution, but to a particular, structured, and effective way of achieving a desired technical outcome.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

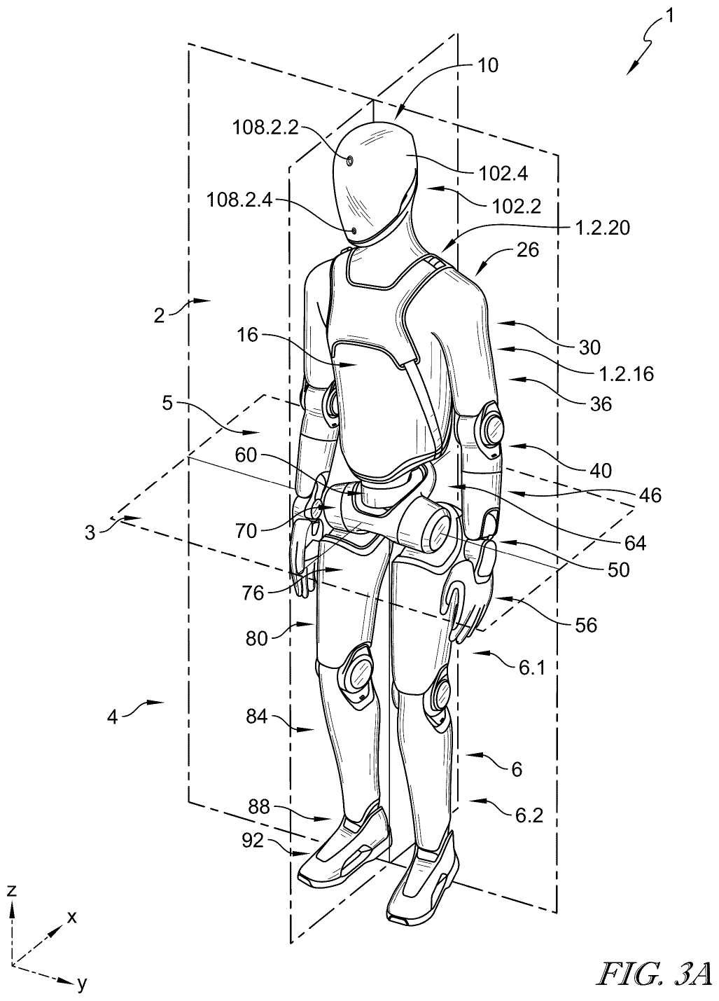

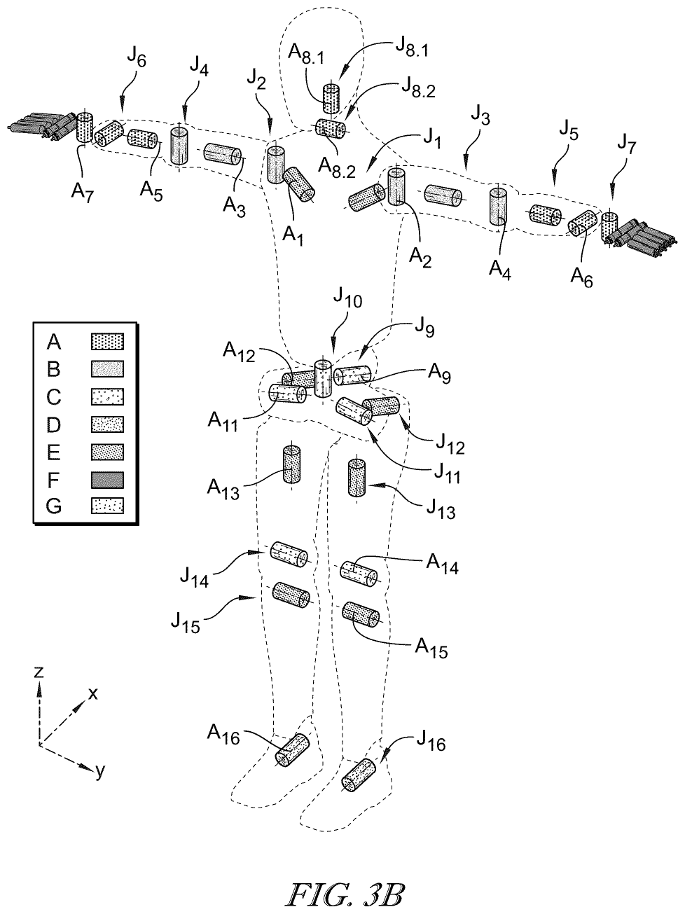

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.
Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.
Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.
Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.
Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).
Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.
Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.
Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (Cₚ) is present and shown.
Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.
Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.
Range of Motion: a range of rotational motion of an actuator about an axis of rotation, where a first and second angle define a rotational limit in opposing rotational directions from a neutral position of the actuator with the limits expressed in Radians.
Degrees of Freedom (DoF): the number of parameters that define the configuration of the kinematic chain and possible movements associated therewith.
Singularities: geometric configurations of the robot's joints in which one or more degrees of freedom are effectively lost due to the alignment or overlap of rotational or translational axes, which in some cases is also affected by interference of extents of components where one or more of the components are moved by the joint.
Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.
Actuator bearing plane (Bₙ): a plane defined mid-width of actuator bearing between parallel edge guides and orthogonal to the rotational axis (Aₙ).
Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

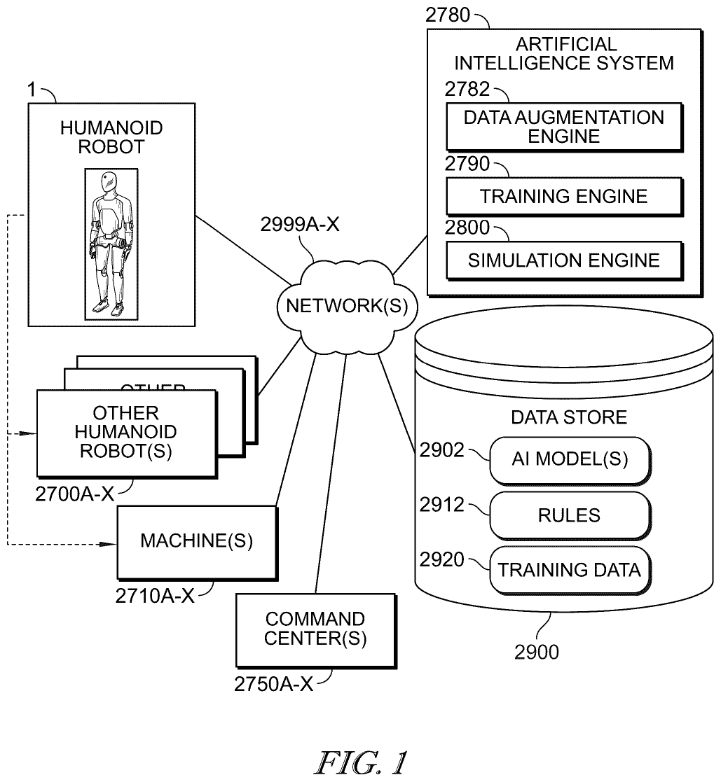

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

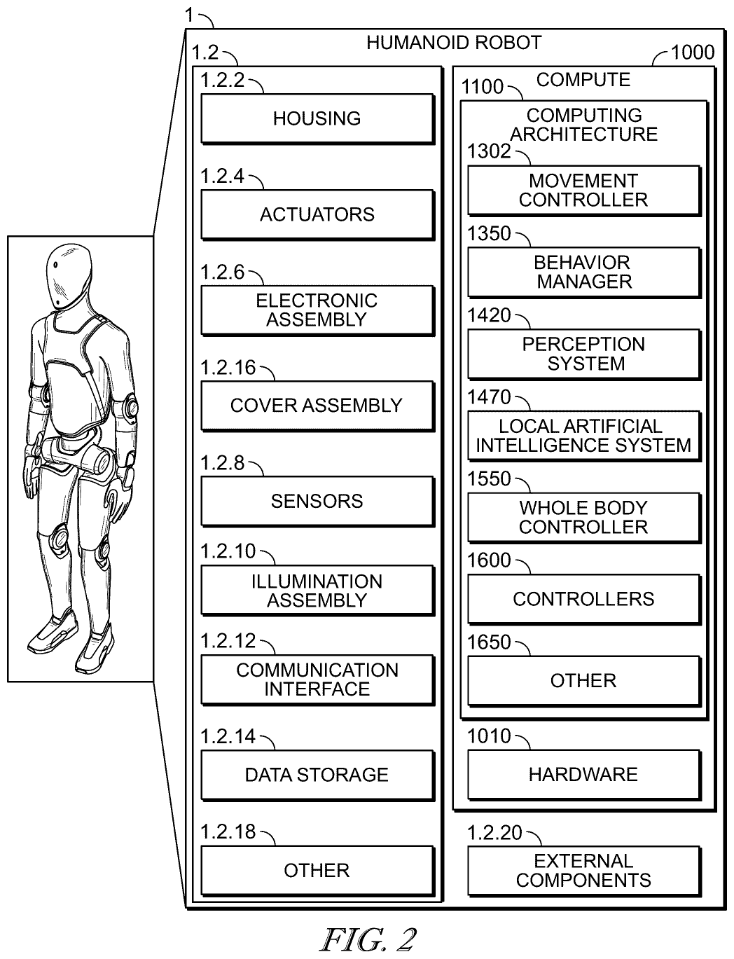

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 1

| | | | Actuator | | |
|---|---|---|---|---|---|
| Actuator | | Qty | Name | Informal Actuator Name(s) | Axis |
| (J1) | 190 | 2 | arm | primary arm | A₁ |
| (J2) | 280 | 2 | shoulder | (none) | A₂ |
| (J3) | 320 | 2 | upper arm twist | upper arm x, upper arm roll | A₃ |
| (J4) | 374 | 2 | elbow | arm z, arm yaw, | A₄ |
| | | | | lower humerus | |
| (J5) | 468 | 2 | lower arm twist | lower arm x, lower arm roll | A₅ |
| (J6) | 484 | 2 | wrist flex | wrist/hand y, wrist/hand | A₆ |
| | | | | pitch, flick | |
| (J7) | 520 | 2 | wrist pivot | wrist/hand z, wrist/hand | A₇ |
| | | | | yaw, wave | |
| (J8.1) | 120 | 1 | head twist | head no | A_{8.1} |
| (J8.2) | 140 | 1 | head nod | head yes | A_{8.2} |
| (J9) | 680 | 1 | torso lean | spine x, torso/spine roll | A₉ |
| (J10) | 620 | 1 | torso twist | spine z, torso/spine yaw | A₁₀ |
| (J11) | 720 | 2 | hip flex | hip y, hip/leg pitch, | A₁₁ |
| | | | | forward kick | |
| (J12) | 768 | 2 | hip roll | hip x, hip/leg roll, | A₁₂ |
| | | | | sideways kick | |
| (J13) | 782 | 2 | leg twist | hip z, hip/leg yaw | A₁₃ |
| (J14) | 820 | 2 | knee | lower thigh, lower leg y, | A₁₄ |
| | | | | lower leg pitch, rear kick | |
| (J15) | 860 | 2 | foot flex | foot y, foot pitch, or | A₁₅ |
| | | | | first ankle | |
| (J16) | 900 | 2 | foot roll | talus, foot roll, foot x, | A₁₆ |
| | | | | second ankle | |

It should be understood that in other embodiments, some of these systems, assemblies, components, and/or parts may be omitted, combined, or replaced with alternative systems, assemblies, components, and/or parts.

A substantial majority of the actuators 1.2.4 (e.g., about twenty-eight of the forty-two actuators or about 66.7% of the actuators) in the illustrative embodiment robot 1 are not connected to a drive linkage; instead, they directly drive the associated part of the robot 1. Conversely, in the illustrative embodiment robot 1, fourteen of the forty-two actuators 1.2.4, or about 33.3% (but more than 10%, and preferably more than 25%), of the rotary actuators are coupled to a drive linkage. Drive linkages are coupled to an aggregate total of twelve rotary actuators contained within both hands 56 and to the foot flex actuators (J15) in each shin 84. These drive linkages allow: (i) the fingers and thumb to be under-actuated, meaning they retain the ability to flex, curl, or rotate around an object while eliminating the need for an actuator to control each joint or degree of freedom, and (ii) the foot 92 to pivot around an axis that is located well forward (e.g., more than 10% of the overall length of the foot) of the center of the drive linkage.

The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

ii. Sensors

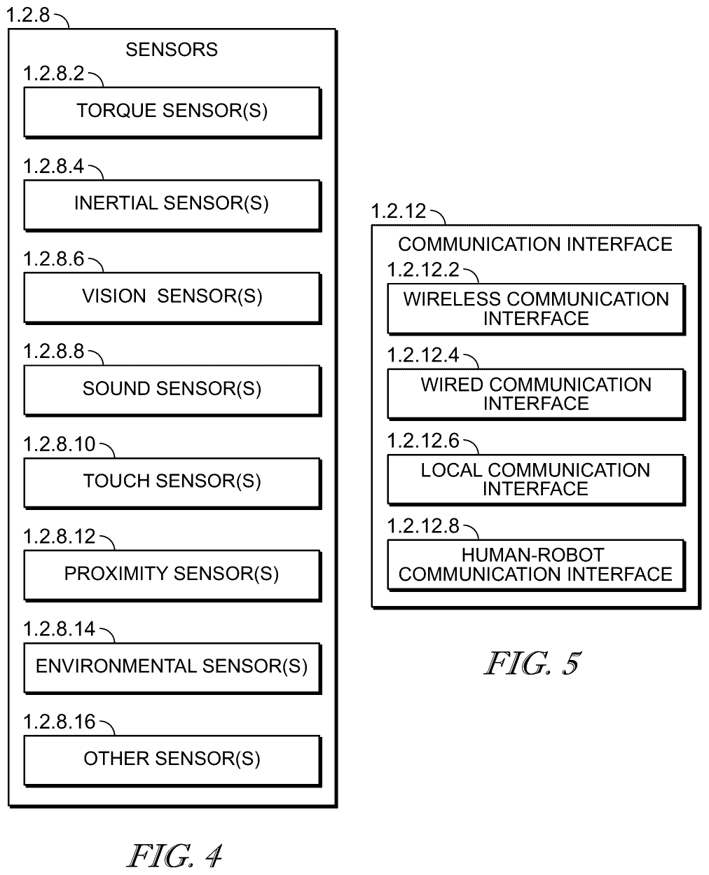

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, visual sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iii. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Referring to FIG. 5, examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

iv. Data Storage

Referring back to FIG. 2, the data storage 1.2.14 may be embodied as any hardware, software, or circuitry for storing, retrieving, and maintaining data for the humanoid robot 1. More particularly, the data storage 1.2.14 may be embodied as any type of device configured for short-term or long-term storage of data. The data storage 1.2.14 may be embodied as memory devices and circuits, solid state drives (SSDs), memory cards, hard disk drives, USB flash drives, or other data storage devices. The data storage 1.2.14 can be embodied as one or more SSDs that expose internal parallelism to components of the humanoid robot 1, allowing the humanoid robot 1, for example, via the compute 1000, to perform storage operations on the data storage 1.2.14 in parallel.

The data storage 1.2.14 may also include memory devices, which may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards, and similar standards, may be referred to as DDR-based standards and communication interfaces of the storage devices that implement such standards may be referred to as DDR-based interfaces.

The memory device is a block addressable memory device, such as those based on NAND or NOR technologies. A memory device may also include a three dimensional crosspoint memory device (e.g., Intel® 3D XPoint® memory), or other byte addressable write-in-place nonvolatile memory devices. In an embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the device itself and/or to a packaged memory product. For data storage 1.2.14, a hierarchical storage architecture may be employed, using faster, smaller caches for frequently accessed data and larger, slower storage for archival or less critical data, optimizing both speed and capacity.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### 1. Movement Controller

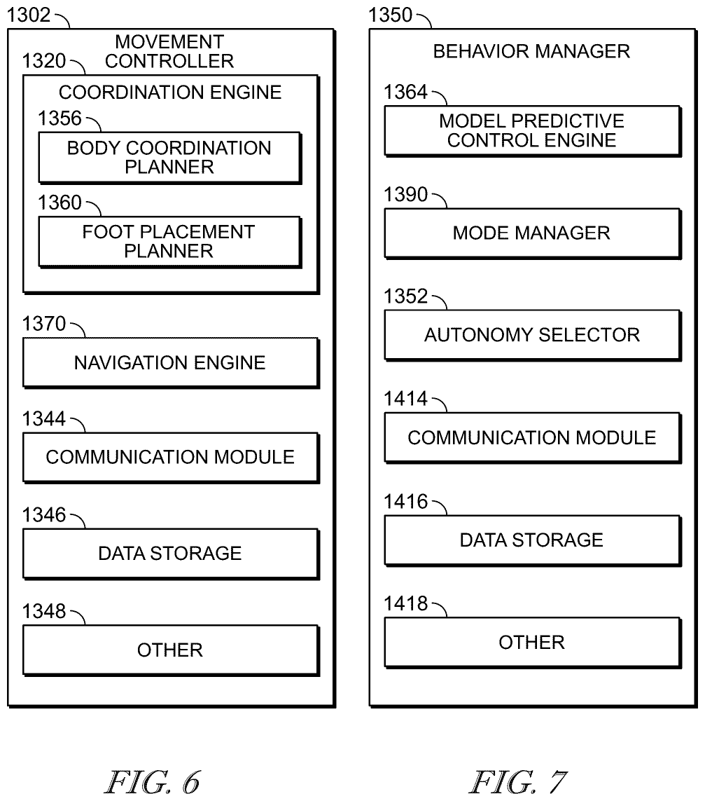

Referring to FIG. 6, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348.

The disclosed movement controller 1302 overcomes limitations associated with conventional robotic systems by enabling the robot 1 to: (i) coordinate its body using the body coordination planner 1356 and foot placement planner 1360 based on instructions from the local AI system 1470 and/or remote AI system 2780, (ii) navigate its world by mapping its environment (e.g., SLAM) and predict movement of objects within said environment, and (iii) communicate with its environment. The movement controller 1302 also enables the robot 1 to adapt in real-time to dynamic environments by continuously monitoring the execution of its plans and comparing the expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can addresses the issue of human-robot collaboration by incorporating models of human behavior and preferences into its decision-making process. This allows the robot 1 to generate plans that are not only efficient from a purely mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during movement such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370 may then be provided to the one or more AI systems 1470, 2780 to enable said systems to plan the next move or task of the robot 1.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without requiring unnecessary processing power that could not be performed on a mobile robot 1. It should be understood that the movement controller 1302 may be omitted and/or consumed by one or more models (e.g., RL trained models) that are contained within the local AI system 1470.

### 2. Behavior Manager

Referring to FIG. 7, the behavior manager 1350 may be embodied as any hardware, software, or circuitry for managing behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several critical technical issues in the field of robotics. One technical issue solved by the behavior manager 1350 is the integration and coordination of multiple modules within a single robotic system. The behavior manager 1350 also solves the technical issue of ensuring that the behaviors of the robot 1 are executed in the correct order, which prevents conflicts and ensures smooth transitions between different actions or states. For example, the manager 1350 might ensure that a “stand up” behavior is completed before a “walk” behavior is initiated, or that an “object recognition” behavior is performed before an attempt to grasp an object is made.

The model predictive control engine 1364 aids in predicting future states of the humanoid robot 1 based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such MPC engine 1364 may select from or utilize different predefined routines or modes to accomplish path planning, obstacle avoidance, object grasping and manipulation, human-robot interaction, task planning and execution, decision making, coordination with other humanoid robots 2700A-X and machines 2710A-X, and safety and regulatory compliance behaviors. Over time, the MPC engine 1364 may communicate with the local AI system 1470 to enable the MPC engine 1364 to refine its selections based on learning algorithms that identify predefined or learned actions for the humanoid robot 1 based on the given tasks, scenarios, and constraints.

Meanwhile the mode manager 1390 can manage modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, etc. Over time, the mode manager 1390 may collaborate with the local AI system 1470 to refine its mode selection based on learning algorithms.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to require some form of manual input for operation.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not previously discussed above relative to the behavior manager 1350, such as cache data, data aggregation modules, data augmentation modules, body part component health management, or calibration data management. It should be understood that the behavior manager 1350 may be omitted and/or consumed by one or more models (e.g., RL trained models) that are contained within the local AI system 1470.

### 3. Perception System

The perception system 1420 may be embodied as any hardware, software, or circuitry for obtaining audiovisual data (e.g., from sensors 1.2.8) and providing this data to the local AI system 1470 for executing AI-based vision techniques (e.g., object detection, image classification, segmentation, object tracking, facial recognition, scene understanding, depth estimation, anomaly detection, reinforcement learning etc.) to generate, from the audiovisual data, one or more three-dimensional (3D) images. The images may further be annotated with contextual data (e.g., foreground/background information, object classification data, labeling, etc.) for additional processing by the local AI system 1470 and the behavior manager 1350. It should be understood that the perception system 1420 may be omitted and/or folded into the local AI system 1470.

### 4. Local AI System

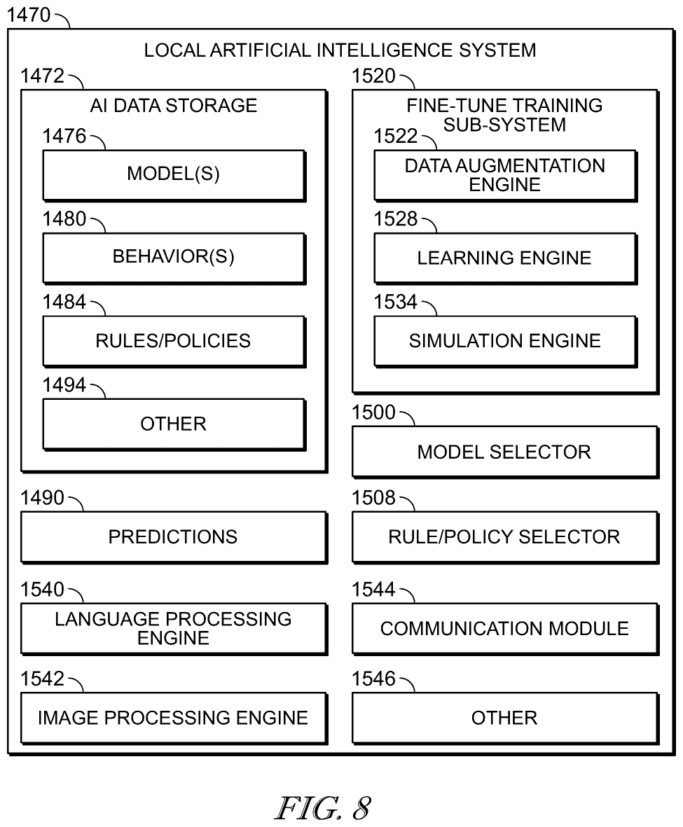

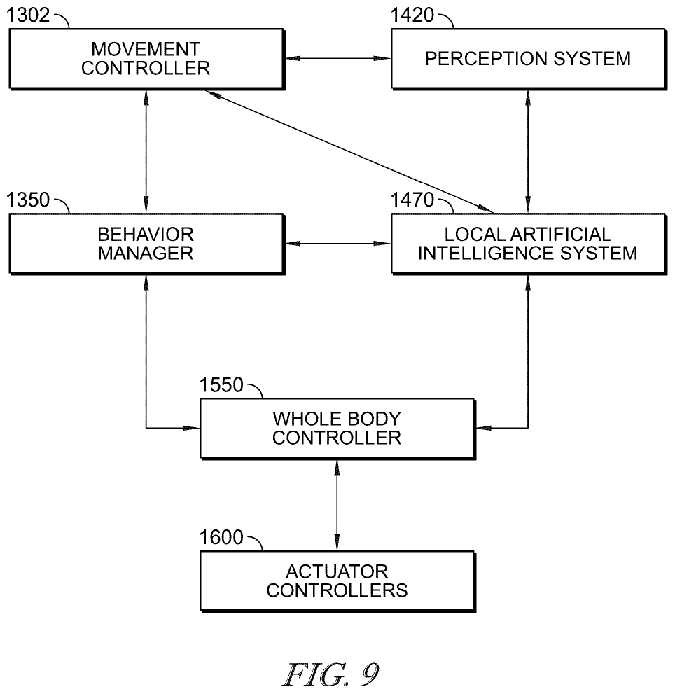

The local AI system 1470 may be embodied as any combination of hardware, software, or circuitry to drive semi- to fully-autonomous perception, learning, and behavior by the humanoid robot 1. The local AI system 1470 may implement various operational configurations wherein: (i) models or architectures run exclusively on the disclosed local AI system 1470, (ii) models or architectures execute with a portion running on the local AI system 1470 and another portion running on the remote AI system 2780, enabling distributed processing capabilities that leverage both edge and cloud computing resources for optimal performance, and (iii) models or architectures run exclusively on the disclosed remote AI system 2780, with the local AI system 1470 serving as an interface for command transmission and data relay. The local AI system 1470 receives detailed description in connection with FIG. 8.

Referring now to FIG. 8, the illustrative local AI system 1470 may include a variety of components, including an AI data storage 1472, predictions 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception 1420, whole body controller 1550, and controllers 1600), establishing bidirectional data flows and control pathways throughout the robotic architecture. In some embodiments, the compute 1000 may only include or primarily include the local AI system 1470, wherein the AI system serves as the central computational hub for all robotic functions. In other words, the local AI system 1470 may not be considered a separate component or system, but instead an integral component of other systems contained within the compute 1000, providing unified intelligence across all subsystems. Thus, a primary technical issue solved by the local AI system 1470 is the challenge of real-time, context-aware decision-making in dynamic environments. Traditional robotic systems often rely on pre-programmed responses or remote processing, which can lead to delays or inappropriate actions in dynamic situations where environmental conditions change rapidly. The local AI system 1470 overcomes this limitation by enabling rapid, localized processing of sensory inputs and the immediate generation of appropriate responses through parallel processing pathways and optimized data structures that minimize latency between perception and action.

Another technical challenge addressed by the local AI system 1470 involves the integration and interpretation of multi-modal sensory data from heterogeneous sources. The humanoid robot 1 employs various sensors, including visual, auditory, tactile, and proprioceptive systems, each operating at different sampling rates and producing data in distinct formats. The AI system 1470 efficiently fuses these diverse data streams in real-time, creating a comprehensive and coherent representation of the state of the robot 1 and its environment through techniques such as temporal alignment, sensor fusion algorithms, and hierarchical data aggregation that reconcile different data modalities into a unified world model. This integrated perception allows for more nuanced and accurate interactions with the physical world and human collaborators, enabling the robot to understand complex scenarios that require simultaneous processing of multiple sensory inputs. The local AI system 1470 also addresses the technical challenge of adaptive learning and continuous improvement in unstructured environments. Unlike static systems, this local AI system 1470 can modify its behavior based on experience and feedback through iterative refinement processes that incorporate both supervised and unsupervised learning paradigms. The system employs advanced machine learning algorithms, potentially including deep reinforcement learning and online learning techniques, to continuously refine its decision-making processes while maintaining stability and safety constraints. This adaptability allows the robot 1 to improve its performance over time, learn new tasks with minimal explicit programming, and adjust to changes in its operational environment or physical capabilities, such as wear on actuators or modifications to its hardware configuration. A further technical challenge resolved by the local AI system 1470 involves the efficient management of the limited computational resources of the robot 1, particularly when operating in autonomous mode without cloud connectivity. The AI system 1470 implements sophisticated task prioritization and resource allocation algorithms, ensuring that time-sensitive processes receive adequate computational power while less urgent tasks are managed efficiently through dynamic scheduling and load balancing mechanisms that adapt to changing computational demands. This dynamic resource management enables the robot 1 to maintain optimal performance across a wide range of operational scenarios, from simple repetitive tasks to complex problem-solving situations that require extensive computational resources.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models 2902 of the remote AI system 2780. These models 1476 may include convolutional neural networks for visual processing, recurrent neural networks for temporal sequence analysis, transformer architectures for multi-modal understanding, and hybrid architectures that combine multiple model types for specialized tasks. The illustrative model selector 1500 selects an appropriate model or set of models 1476 given a specified task, scenario, or constraint, utilizing a meta-learning approach that considers historical performance data and current operational conditions. For example, the model selector 1500 may select a given model based on considerations such as the task complexity, a cost to perform the task including computational and energy costs, performance efficiency metrics including latency and throughput requirements, the environment and surroundings characteristics including lighting conditions and obstacle density, resource management requirements including available memory and processing power, or the current health status of the humanoid robot 1 or its components including battery level and actuator conditions. Over time, the model selector 1500 may be refined based on learning algorithms that identify efficient models 1476 for given tasks, scenarios, and constraints through performance tracking and optimization feedback loops that analyze success rates, resource utilization, and task completion times. In an embodiment, the model may be selected in response to operator input as an alternative to automated selection, providing human oversight when desired. This manual selection capability may be useful, e.g., during the initialization of the humanoid robot 1 or during specialized operational modes such as debugging, maintenance, or experimental task execution.

The illustrative rule and policy selector 1508 may select one or more of the rules and policies 1484 that are stored in the AI data storage 1472 to be enforced during the operation of the humanoid robot 1, e.g., based on operator input given a context, environment, compliance and regulatory jurisdiction, safety considerations, and operational parameters. These rules and policies 1484 may include safety constraints that prevent the robot from entering dangerous states, ethical guidelines that govern interactions with humans, operational boundaries that define acceptable ranges of motion and force application, and task-specific protocols that ensure consistency in execution. In an embodiment, the rule and policy selector 1508 may automatically learn efficient methods for adapting to selected rules and policies over time through reinforcement learning and pattern recognition algorithms that identify successful strategies for satisfying multiple, potentially conflicting constraints.

The language processing engine 1540 may be embodied as any combination of hardware, software, or circuitry for obtaining, parsing, interpreting, and understanding natural language directives and concepts, and also for generating natural language speech that enables bidirectional communication with human operators. For example, the language processing engine 1540 may translate speech-to-text and text-to-speech through acoustic modeling, language modeling, and pronunciation modeling components, utilizing deep learning architectures such as transformer-based models for contextual understanding and sequence-to-sequence models for translation tasks. The language processing engine 1540 may also incorporate semantic parsing capabilities to extract structured representations from unstructured text, enabling the robot to understand complex commands with multiple sub-goals and conditional logic. The image processing engine 1542 may be embodied as any combination of hardware, software, or circuitry for performing object detection, image classification, segmentation, object tracking, facial recognition, scene understanding, depth estimation, anomaly detection, or reinforcement learning on input visual data (e.g., as obtained by sensors 1.2.8 such as cameras or in preloaded training data). The image processing engine 1542 may utilize convolutional neural networks, vision transformers, and hybrid architectures that combine local and global feature extraction for comprehensive visual understanding across multiple scales and resolutions.

The training sub-system 1520 may be embodied as any hardware, software, or circuitry configured to refine models 1476 and behaviors 1480 based on observed data and training data, enabling continuous improvement of the robot's capabilities through experience. The training sub-system 1520 may include a data augmentation engine 1522, a learning engine 1528, and a simulation engine 1534. The data augmentation engine 1522 may be embodied as any hardware, software, or circuitry configured to increase the size and diversity of training data through techniques such as rotation, scaling, cropping, and synthetic data generation, similar to the data augmentation engine 2782 of the remote AI system 2780. The data augmentation engine 1522 may also employ advanced techniques such as style transfer to create visually diverse training samples, adversarial examples to improve robustness, and procedural generation to create entirely synthetic training scenarios. The learning engine 1528 may be embodied as any hardware, software, or circuitry for training the AI models 1476, given a set of rules and policies 1484, behaviors 1480, and training data, similar to the training engine 2790 of the remote AI system 2780. The learning engine 1528 may implement various optimization algorithms including stochastic gradient descent, Adam, and second-order methods, along with regularization techniques such as dropout, batch normalization, and weight decay to prevent overfitting. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. The simulation engine 1534 may incorporate physics engines for accurate dynamics simulation, sensor models for realistic perception simulation, and environmental models for testing the robot's performance under various conditions. Compared to the remote AI system 2780, the AI fine-tuning conducted by the local AI system 1470 may be localized to the specific humanoid robot 1, which can be advantageous in situations such as those where the humanoid robot 1 performs a specific task repeatedly or operates in a consistent environment, allowing for highly specialized optimization that would not generalize well to other robots in the fleet.

The other 1546 may include a communications module that is embodied as any combination of hardware, software, and/or circuitry to enable components of the local AI system 1470 to communicate with one another and with other components of the humanoid robot 1 (such as of the compute 1000). The communications module may implement various protocols including high-speed serial interfaces, shared memory architectures, and message-passing systems to ensure low-latency data transfer between components. It should be understood that the controllers may be omitted and/or consumed by one or more models (e.g., RL trained models) that are contained within the local AI system 1470, providing end-to-end learning capabilities that directly map from sensory inputs to motor commands.

a. Hierarchical Architectures

Disclosed herein are hierarchical architectures of the BAM for humanoid robots, designed to enable large, computationally intensive models at the top levels to provide deliberative reasoning, while smaller, more efficient models towards the lower levels of the hierarchy provide quick, reactive actions to accommodate changing environmental conditions. This hierarchical arrangement creates a cognitive pipeline where abstract goals are progressively refined into concrete physical actions through multiple layers of processing and decision-making, with each layer operating at different temporal and spatial scales. The models within each layer of the hierarchy can be of any suitable type, including but not limited to large language models (LLMs), vision language models (VLMs), multimodal large language models (MLLMs), other machine learning models, neural network models, transformer-based models, state space models (e.g., Mamba), or any hybrid thereof, providing flexibility in architectural design based on specific task requirements and computational constraints. In some embodiments, the entire hierarchy of models can be trained in an end-to-end fashion through gradient propagation across all layers, enabling coherent learning where high-level reasoning and low-level control are jointly optimized. This allows for fine-tuning with techniques such as behavioral cloning loss at the lowest level, with the resulting gradients propagated back through the hierarchy to the high-level reasoning network, thereby ensuring that the deliberative planning of the large models can be grounded in the physical realities and capabilities of the robot's low-level execution, creating a bidirectional flow of information that improves both planning accuracy and execution precision.

### i. First Model Architecture

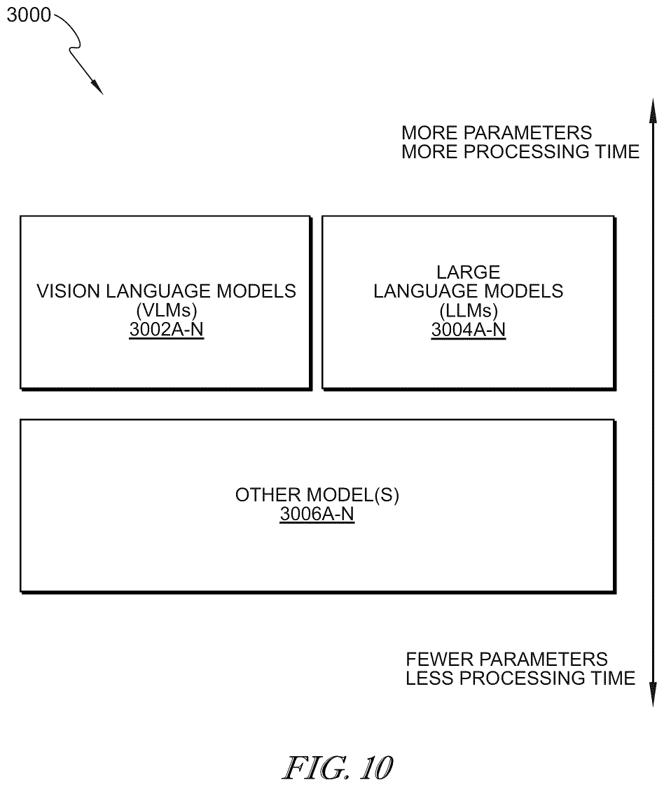

Referring now to FIG. 10, a first embodiment of a hierarchical model architecture 3000 establishes a foundational division between high-level cognition and low-level action, creating a two-tier system that balances computational complexity with real-time responsiveness. In this architecture, the highest level comprises one or more vision language models (VLMs) 3002A-N and one or more large language models (LLMs) 3004A-N. These models, 3002A-N and 3004A-N, may operate in parallel on the same hierarchical level and are characterized by having a substantially larger number of parameters and consequently requiring more processing time and power relative to the lower-level models, typically containing billions of parameters that enable complex reasoning capabilities. The VLMs 3002A-N can be specialized for processing and interpreting complex visual data streams from the sensors of robot 1, such as cameras, to build a semantic understanding of the environment, including object recognition, spatial relationships, and scene context through convolutional and attention-based mechanisms that capture both local and global visual features. The VLMs 3002A-N may also incorporate temporal modeling capabilities to understand dynamic scenes and track objects across time, enabling the robot to anticipate future states based on observed motion patterns. Concurrently, the LLMs 3004A-N may process linguistic information, such as converting a user's spoken commands into tokenized text and interpreting the intent and constraints of a given task through contextual embeddings and semantic parsing that can handle ambiguous or complex natural language instructions. Together, these higher-level models may perform the deliberative, long-horizon planning to decompose a complex goal into a logical sequence of achievable sub-goals through hierarchical task decomposition algorithms that consider both feasibility and efficiency.

The bottom level of the architecture 3000 comprises one or more models 3006A-N, wherein the models can be of any type suitable for real-time control. The models 3006A-N are, by design, computationally lightweight, characterized by having significantly fewer parameters and requiring substantially less processing time, typically containing millions rather than billions of parameters. These models may be optimized for speed and efficiency through techniques such as model pruning, quantization, and knowledge distillation, making them suitable for executing as the lower-level, real-time control models in the hierarchy with update rates exceeding 100 Hz. The models function as the policy network, receiving strategic guidance, discrete sub-goals, or continuous contextual information from the higher-level VLMs 3002A-N and LLMs 3004A-N through a structured communication protocol that may include attention mechanisms, latent embeddings, or explicit symbolic representations. The models 3006A-N then translate this high-level directive into a continuous stream of immediate, low-level control commands, such as joint torques and position targets, for the humanoid robot's actuators, enabling fluid and reactive motion through predictive control algorithms that account for dynamics, constraints, and environmental interactions.

### ii. Second Model Architecture

Referring now to FIG. 11, a second embodiment of a hierarchical model architecture 3010 introduces an integrated approach to high-level reasoning that unifies multiple modalities within single models. In this architecture, the highest level comprises one or more multimodal large language models (MLLMs) 3012A-N and, in some implementations, one or more specialized large language models (LLMs) 3014A-N. The defining characteristic of the MLLMs 3012A-N involves their inherent capability to process and reason over multiple, diverse modalities of data—such as interleaved images, text, and audio—within a single, unified model through cross-modal attention mechanisms and shared embedding spaces that enable direct interaction between different data types. This integrated processing allows the MLLM to capture complex, cross-modal relationships that may be lost in systems with separate vision and language modules, leading to a more nuanced and holistic understanding of the robot's environment and the user's intent, such as understanding pointing gestures in conjunction with verbal commands or interpreting emotional context from both facial expressions and voice tone. As with the first embodiment, these highest-level models are computationally intensive, possessing a large number of parameters to facilitate their sophisticated reasoning and planning capabilities, often exceeding several billion parameters to enable comprehensive multi-modal understanding.

The lowest level of the architecture 3010 again comprises one or more models 3016A-N, wherein the models can be of any type optimized for control execution. Similarly, these models 3016A-N can be lightweight models that process fewer parameters and consume significantly fewer processing resources, enabling high-frequency operation that matches or exceeds the update rate of the robot's control systems. In this configuration, the models 3016A-N benefit from the rich, pre-processed, multimodal context provided by the MLLMs 3012A-N, as well as LLMs 3014A-N through structured latent representations that encode both visual and linguistic information in a unified format. This allows the models 3016A-N to generate control signals that are not only reactive to immediate physical stimuli but are also deeply informed by the broader situational context, enabling the robot to perform actions that are both fluid and contextually appropriate based on the strategic guidance provided by the MLLMs 3012A-N and any accompanying LLMs 3014A-N, such as adjusting manipulation strategies based on object properties inferred from both visual appearance and linguistic descriptions.

### iii. Third Model Architecture

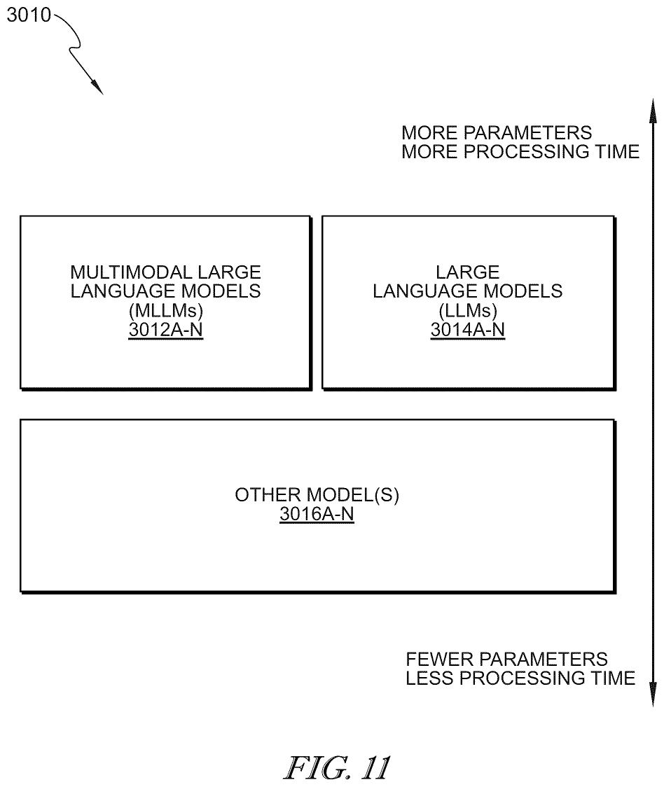

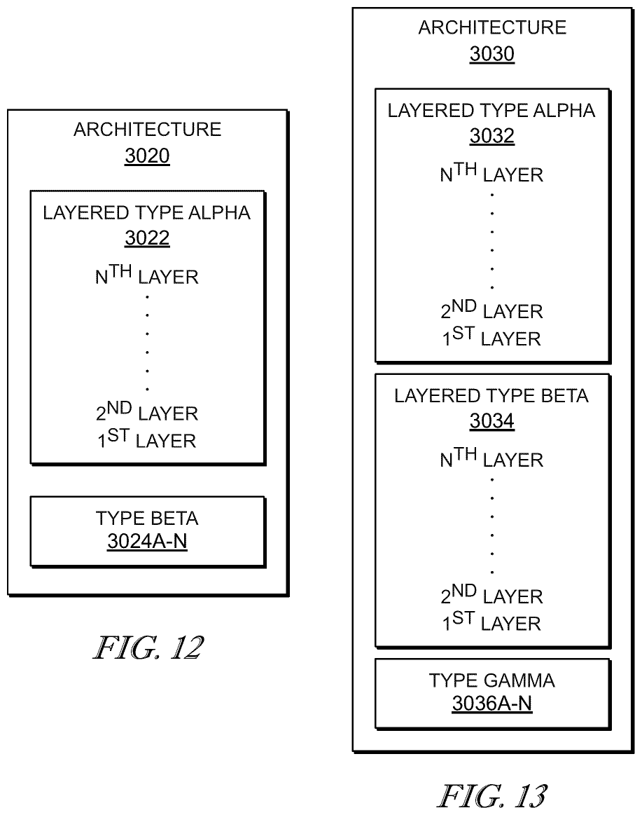

Referring now to FIG. 12, a third embodiment of a hierarchical model architecture 3020 introduces the concept of a deeper, layered hierarchy for high-level planning that enables progressive refinement of abstract goals. This architecture demonstrates the use of a vertically integrated stack of models at the higher levels, creating multiple stages of abstraction and planning. The architecture 3020 includes a stack of layered MLLMs 3022, representing a sophisticated multi-level planning system. This stack may be composed of multiple MLLM instances arranged in a functional hierarchy, from a 1st layer up to an Nth layer, where each layer specializes in different levels of abstraction and temporal horizons. These layers may be of the same or different sizes and can perform planning at cascading levels of abstraction, forming a “planning cascade” through hierarchical decomposition that progressively transforms abstract goals into concrete actions. For example, the Nth layer at the top may receive a very abstract, long-horizon user command, such as “clean the house,” and decompose it into major sub-tasks like “clean the kitchen” and “tidy the living room” through task planning algorithms that consider resource availability, temporal constraints, and task dependencies. These sub-tasks can then be passed down to an intermediate layer, which further decomposes them into more concrete steps (e.g., “clear the table,” “load the dishwasher”) through action planning mechanisms that account for the current state of the environment and available tools. This process continues until the 1st layer (the lowest level of the MLLM stack), which may output highly granular, immediately actionable sub-goals, such as “plan a trajectory to the coffee mug on the table” through motion planning algorithms that consider obstacle avoidance, energy efficiency, and kinematic constraints.

The lowest level of the overall architecture 3020 may comprise a single or a plurality of models 3024A-N, wherein the models can be of any type suitable for real-time execution. These models may function as the final action-generation layer, receiving the stream of refined, detailed instructions from the 1st (lowest) layer of the layered MLLMs 3022 through a structured interface protocol that may include command queues, state machines, or continuous control signals. Similar to the architectures 3000, 3010, models 3024A-N may be computationally lightweight, having significantly fewer parameters and requiring substantially less processing time to meet real-time control requirements. The models 3024A-N translate instructions from the layered MLLMs 3022 into a continuous stream of immediate, low-level robot control commands through inverse kinematics and trajectory optimization that ensures smooth, collision-free motion. This hierarchical decomposition of the task significantly reduces the cognitive load on these models, allowing them to focus exclusively on their primary function: converting specific sub-goals into high-frequency, stable, and reactive actuator commands that account for dynamic disturbances and maintain balance during locomotion and manipulation.

### iv. Fourth Model Architecture

Referring now to FIG. 13, a fourth embodiment of a hierarchical model architecture 3030 expands on the concept of layered models by employing multiple and specialized deep stacks for processing different modalities, enabling domain-specific expertise at each processing level. The architecture 3030 includes a stack of layered VLMs 3032 and a separate, parallel or sequential, stack of layered LLMs 3034. Each stack comprises multiple layers, from a 1st layer to an Nth layer, with each layer potentially specializing in different aspects of its respective modality. This configuration allows for specialized, deep, and hierarchical processing of both visual and linguistic information to occur concurrently or sequentially through dedicated processing pipelines that can be optimized independently for their specific data types. For instance, the layered VLMs 3032 can build a sophisticated, multi-layered understanding of the visual scene, from low-level feature extraction at the 1st layer including edge detection and texture analysis to high-level object relationship modeling and temporal event tracking at the Nth layer through progressive abstraction that captures increasingly complex visual patterns. The visual processing may include specialized layers for depth estimation, motion prediction, and affordance detection, providing comprehensive scene understanding. Simultaneously or sequentially, the layered LLMs 3034 can manage a complex, evolving dialogue with a user, maintaining conversational history and resolving ambiguities over multiple turns through context tracking and dialogue state management that ensures coherent multi-turn interactions.

The outputs from these specialized stacks are then fused or integrated at one or more levels of the hierarchy to form a comprehensive, multimodal state representation through fusion algorithms and attention mechanisms that combine visual and linguistic information optimally. This fusion may occur at multiple points in the hierarchy, allowing for early, middle, and late fusion strategies that capture different types of cross-modal interactions. This integrated guidance can then be provided to the lowest level of the architecture, which comprises a single or a plurality of models 3036A-N. The models utilize this rich, fused information from the parallel or sequential stacks of layered VLMs 3032 and layered LLMs 3034 to generate the final, real-time control outputs for the robot through control synthesis algorithms that translate high-level multimodal commands into precise motor actions. The primary advantage of this architecture lies in its ability to perform deep, specialized reasoning within each modality before integration, leading to exceptionally robust performance in complex scenarios that involve both intricate visual interpretation and nuanced linguistic interaction, such as following cooking recipes that require understanding both visual demonstrations and textual instructions.

The hierarchical model architectures of FIGS. 10-13 represent illustrative examples that demonstrate the flexibility and scalability of the disclosed approach. One or more other combinations of models can be deployed in a hierarchical model architecture for controlling the humanoid robot 1, depending on specific task requirements, computational resources, and performance objectives. Any combination of LLMs, VLMs, MLLMs, other machine learning models, neural network models, transformer-based models, and/or any combination or hybrid thereof can be used in the hierarchical model architecture for deployment, providing adaptability to diverse operational scenarios. any quantity of LLMs, VLMs, MLLMs, and/or other models can be used in the deployed architecture, allowing for scaling based on available computational resources. Additionally or alternatively, any number of hierarchical layers can be used in the deployed architecture, enabling fine-grained control over the abstraction and planning hierarchy. Each layer size may also be defined independently of each other, providing flexibility in resource allocation. For example, the layers in the deployed architecture can each have varying context window size, number/quantity of parameters, and/or processing speed/execution rate, allowing for optimization of computational resources and response times at each level of the hierarchy through careful architectural design that balances capability with efficiency.

Any known MLLM, VLM, or LLM may be used in the hierarchical model architecture 3000, providing compatibility with existing pre-trained models and enabling transfer learning from large-scale datasets. Examples of these models include GPT-4o, Gemini 1.5, Claude 3, PaLM-E, MM1, Video-LLaMA, and any model or model architecture described in any one or combination of the following papers: Radford, Alec, et al. “Learning transferable visual models from natural language supervision.” International conference on machine learning. PMLR, 2021, Li, Yangguang, et al. “Supervision exists everywhere: A data efficient contrastive language-image pre-training paradigm.” arXiv preprint arXiv:2110.05208 (2021), Yao, Lewei, et al. “Filip: Fine-grained interactive language-image pre-training.” arXiv preprint arXiv:2111.07783 (2021), Rombach, Robin, et al. “High-resolution image synthesis with latent diffusion models.” Proceedings of the IEEE/CVF conference on computer vision and pattern recognition. 2022, Li, Junnan, et al. “Blip: Bootstrapping language-image pre-training for unified vision-language understanding and generation.” International conference on machine learning. PMLR, 2022, Zhang, Renrui, et al. “Llama-adapter: Efficient fine-tuning of language models with zero-init attention.” arXiv preprint arXiv:2303.16199 (2023), Liu, Haotian, et al. “Visual instruction tuning.” Advances in neural information processing systems 36 (2024), Liu, Haotian, et al. “Improved baselines with visual instruction tuning.” Proceedings of the IEEE/CVF Conference on Computer Vision and Pattern Recognition. 2024, Lin, Ji, et al. “Vila: On pre-training for visual language models.” Proceedings of the IEEE/CVF Conference on Computer Vision and Pattern Recognition. 2024, Jin, Yang, et al. “Unified Language-Vision Pretraining in LLM with Dynamic Discrete Visual Tokenization. arXiv 2024.” arXiv preprint arXiv:2309.04669, Maniparambil, Mayug, et al. “Do Vision and Language Encoders Represent the World Similarly?.” Proceedings of the IEEE/CVF Conference on Computer Vision and Pattern Recognition. 2024, Liu, Daizong, et al. “A Survey of Attacks on Large Vision-Language Models: Resources, Advances, and Future Trends.” arXiv preprint arXiv:2407.07403 (2024), Chang, Yupeng, et al. “A survey on evaluation of large language models.” ACM Transactions on Intelligent Systems and Technology 15.3 (2024): 1-45, Yin, Shukang, et al. “A survey on multimodal large language models.” arXiv preprint arXiv:2306.13549 (2023), Zhang, Duzhen, et al. “Mm-llms: Recent advances in multimodal large language models.” arXiv preprint arXiv:2401.13601 (2024), Vaswani, A. “Attention is all you need.” Advances in Neural Information Processing Systems (2017), Radford, A. “Improving language understanding by generative pre-training.” (2018), Wang, Wei, et al. “Structbert: Incorporating language structures into pre-training for deep language understanding.” arXiv preprint arXiv:1908.04577 (2019), Radford, Alec, et al. “Language models are unsupervised multitask learners.” OpenAI blog 1.8 (2019): 9, Liu, Yinhan. “Roberta: A robustly optimized bert pretraining approach.” arXiv preprint arXiv:1907.11692 (2019), Sanh, V. “DistilBERT, A Distilled Version of BERT: Smaller, Faster, Cheaper and Lighter.” arXiv preprint arXiv:1910.01108 (2019), Raffel, Colin, et al. “Exploring the limits of transfer learning with a unified text-to-text transformer.” Journal of machine learning research 21.140 (2020): 1-67, Brown, Tom B. “Language models are few-shot learners.” arXiv preprint arXiv:2005.14165 (2020), Touvron, Hugo, et al. “Llama 2: Open foundation and fine-tuned chat models.” arXiv preprint arXiv:2307.09288 (2023), Schulman, John, et al. “Proximal policy optimization algorithms.” arXiv preprint arXiv:1707.06347 (2017), Radford, Alec, et al. “Learning transferable visual models from natural language supervision.” International conference on machine learning. PMLR, 2021, Li, Yangguang, et al. “Supervision exists everywhere: A data efficient contrastive language-image pre-training paradigm.” arXiv preprint arXiv:2110.05208 (2021), Chen, Zhe, et al. “Internvl: Scaling up vision foundation models and aligning for generic visual-linguistic tasks.” Proceedings of the IEEE/CVF Conference on Computer Vision and Pattern Recognition. 2024, all of which are incorporated herein by reference and in their entirety for any purpose.

As described above, lower-level models can be designed to function as the lower and reactive layer of the embodied AI architectures, providing the high-frequency control signals essential for stable robot operation. These models represent a lightweight, computationally efficient model specifically engineered to generate humanoid control information in real-time, thereby empowering the robot to adapt instantly and gracefully to changing environmental conditions through predictive control mechanisms and adaptive response generation that account for sensor noise, modeling uncertainties, and external disturbances. By operating downstream from the larger, more deliberative models which inherently require more processing time, the disclosed model can execute its functions at a very high frequency, generating accurate and stable humanoid control information for seamless, real-time physical interaction through optimized inference pipelines and hardware acceleration that may include specialized processors such as GPUs, TPUs, or custom ASICs designed for neural network inference.

One or more low-level models can be deployed in the hierarchical model architecture, enabling specialized control for different aspects of robot behavior. Larger models can be used for determining general actions of the humanoid robot 1, while smaller models can be used for determining specific actions of specific regions, parts, and/or actuators of the humanoid robot 1, creating a distributed control architecture that matches computational complexity to control requirements. As merely illustrative examples, a first small model can be used to determine actions performed by a left arm of the humanoid robot 1, a second small model can be used to determine actions performed by a right arm of the humanoid robot 1, a third small model can be used to determine actions performed by a left leg, a fourth small model can be used to determine actions performed by a right leg, a fifth small model can be used to determine actions performed by a torso, a sixth small model can be used to determine actions performed by a head of the humanoid robot 1, etc., with each specialized model optimized for the specific kinematics and dynamics of its assigned body part. Any combination of the small models can be deployed in parallel in a same layer of the hierarchical model architecture, enabling concurrent control of multiple body parts with appropriate coordination mechanisms. Any combination of the small models can be deployed in series, in different layers of the architecture, creating cascading control where higher-level models provide targets for lower-level models. As another example, a large-size model can be trained and deployed for determining actions of the humanoid robot 1 as a whole, considering full-body coordination and balance. One or more medium-size models can be trained and deployed in one or more layers underneath the large-size model to determine actions of each region of the humanoid robot 1 (e.g., left arm, right arm, left leg, right leg, torso, head), translating whole-body objectives into region-specific control targets. One or more small-size models can further be trained and deployed in one or more layers underneath the medium-size model to determine controls of each actuator in the humanoid robot 1, converting region-level commands into precise motor control signals.

These low-level models may be of any type of artificial intelligence models, machine learning models, neural network-based models, deep learning models, or generative artificial intelligence models. Further, the low-level models may be implemented as and/or including: (i) transformer family architectures (e.g., decoder-only with causal masking; encoder-only (BERT) with bidirectional attention; cross-attention encoder-decoder (T5) with separated encoding and decoding; ViT/DeiT for image patches, Swin with hierarchical windows; Longformer with sparse attention, BigBird with random and global tokens, Reformer with locality-sensitive hashing, Linformer with linear complexity, Performer with kernel-based attention; Transformer-XL with segment-level recurrence, Memorizing Transformer with explicit memory; Cross-Modal Bridges for multi-modal fusion, Q-Former for query-based extraction; Perceiver/Perceiver-IO with latent bottlenecks; Graph Transformers for structured data), (ii) state-space/long-sequence & recurrence models (e.g., S4/S5 with structured matrices; Mamba/Mamba-2 with selective state spaces; RetNet with retention mechanisms; Liquid Models with continuous-time dynamics; Hyena/Long Convolutions with implicit parameterization; Linear-Attention Kernels with softmax alternatives), (iii) recurrent neural networks (e.g., LSTM/GRU/SRU with gating mechanisms; RWKV with linear complexity; RNN-T for sequence transduction), (iv) convolutional neural network architectures (e.g., ResNet/EfficientNet/ConvNeXt with modern design principles; U-Net for dense prediction; Sparse/3D CNNs (Minkowski) for point clouds), (v) graph neural network & geometric architectures (e.g., GCN/GAT/GIN with message passing; GraphSAGE with sampling; EGNN with equivariance; SE(3)-Transformers with group theory; E(n)-Equivariant CNNs preserving symmetries), (vi) spiking neural networks (e.g., Event-Driven SNNs with temporal coding), (vii) MLP-Style Vision architectures (e.g., MLP-Mixer with token mixing; gMLP with gating; MetaFormer-Style Variants abstracting transformer components), (viii) audio-centric backbones (e.g., Conformer combining convolution and attention; TasNet/Conv-TasNet for source separation; wav2vec/HuBERT for self-supervised speech; Diffusion Vocoders for waveform generation), (ix) sets/point clouds/3D representations (e.g., DeepSets/Set Transformer with permutation invariance; PointNet/PointNet++ with hierarchical features; Point Transformer adapting attention; KPConv with kernel convolutions; Minkowski networks for sparse voxels), (x) implicit neural representations/neural fields (e.g., SIREN with periodic activations; NeRF Family Including Mip-NeRF with anti-aliasing, Instant-NGP with hash encoding; DeepSDF for shape representation; 3D Gaussian Splatting for fast rendering), (xi) autoregressive models (e.g., Token/Patch/Audio AR with sequential generation; PixelCNN/RNN for images; AR Transformers with causal masking), (xii) variational autoencoder & latent-variable models (e.g., β-VAE with disentanglement; Hierarchical VAEs with multiple scales), (xiii) diffusion/score-based models (e.g., LDMs in latent space; DiT with transformers; Video Diffusion with temporal consistency; Vocoders for audio synthesis), (xiv) normalizing flows (e.g., RealNVP with coupling layers; Glow with invertible convolutions; Neural ODE Flows with continuous dynamics; FFJORD with free-form Jacobians), (xv) generative adversarial networks (e.g., StyleGAN with style modulation; BigGAN with class conditioning), (xvi) energy-based models (e.g., Including Boltzmann/RBMs with stochastic units), (xvii) masked/denoising objectives (e.g., BERT-Style MLM for language; MAE for images; Denoising AEs with corruption), (xviii) contrastive/self-distillation methods (e.g., CLIP for vision-language; SimCLR for visual representations; MoCo with momentum encoding; DINO/iDINO with self-distillation), (xix) tokenization/latent tokenizers (e.g., VQ-VAE/VQ-GAN with discrete codes; Tokenizer-Decoder Stacks for compression), (xx) preference/RL fine-tuning (e.g., RLHF/RLAIF with human feedback; DPO for direct optimization), (xxi) mixture-of-experts (MoE) systems (e.g., Switch with routing; GShard with sharding; DeepSeek-MoE with sparse activation), (xxii) retrieval & external memory (e.g., RAG for knowledge grounding; kNN-LM with nearest neighbors; NTM with differentiable memory; DNC with addressing mechanisms), (xxiii) world/dynamics models (e.g., PlaNet/RSSM/Dreamer with latent dynamics; MuZero-Style with planning; Latent ODE Dynamics with continuous time; Diffusion World Models for stochastic environments), (xxiv) multimodal fusion strategies (e.g., Cross-Attention Bridges between modalities; FiLM-Style Conditioning with affine transformations; Gated Fusion with learnable weights; Q-Former/Perceiver Latents for bottleneck processing), any combination thereof through hybrid architectures, and/or any other type that advances the state of the art based on this disclosure. This Application contemplates that the models could use or include any model type disclosed in any reference disclosed herein, enabling incorporation of future advances in machine learning architectures.

The design advantages of the hierarchical AI model architectures for humanoid robots described above can be further illustrated in the following distributed model and configuration examples that demonstrate practical deployment strategies. In these examples, distributed deployments are actualized in a foundational BAM through the deep integration of a multi-tiered memory architecture across the distributed models, creating a cognitive system that mirrors biological memory hierarchies. This co-design of cognitive models, memory systems, and physical deployment locations enables the humanoid robot 1 to perform complex, long-horizon tasks with a combination of deep reasoning and real-time reactivity through coordinated processing across multiple computational layers that may span from cloud servers to edge devices.

Any combination of the LLMs, VLMs, MLLMs, and/or other models in the deployed architecture can be run locally on the edge (e.g., at the humanoid robot 1) or remotely (e.g., at the remote AI system(s) 2780 or otherwise separate from the humanoid robot 1), providing flexibility in balancing computational load, latency requirements, and privacy considerations. As an illustrative example, a large MLLM can be executed remotely to process all image/video data that may be generated by sensors at the humanoid robot 1, leveraging cloud computing resources for computationally intensive visual understanding tasks. A LLM can be executed in a layer beneath the large MLLM or alongside the large MLLM in the same layer, and configured to process speech or other audio input to text input, potentially incorporating speaker identification and emotion recognition. The LLM can be executed on the edge at the humanoid robot 1 or remotely with the large MLLM, depending on latency requirements and available computational resources. In this example, one or more lightweight model can be deployed on the edge at the humanoid robot 1 in a layer underneath the large MLLM and/or the LLM. The low-level model can quickly and accurately determine, on the edge, actions to be performed by the humanoid robot 1 based on output or determinations made by the large MLLM, the LLM, or a combination thereof through optimized communication protocols and latency-aware processing that minimize the delay between high-level planning and low-level execution.

### v. Second Model Architecture

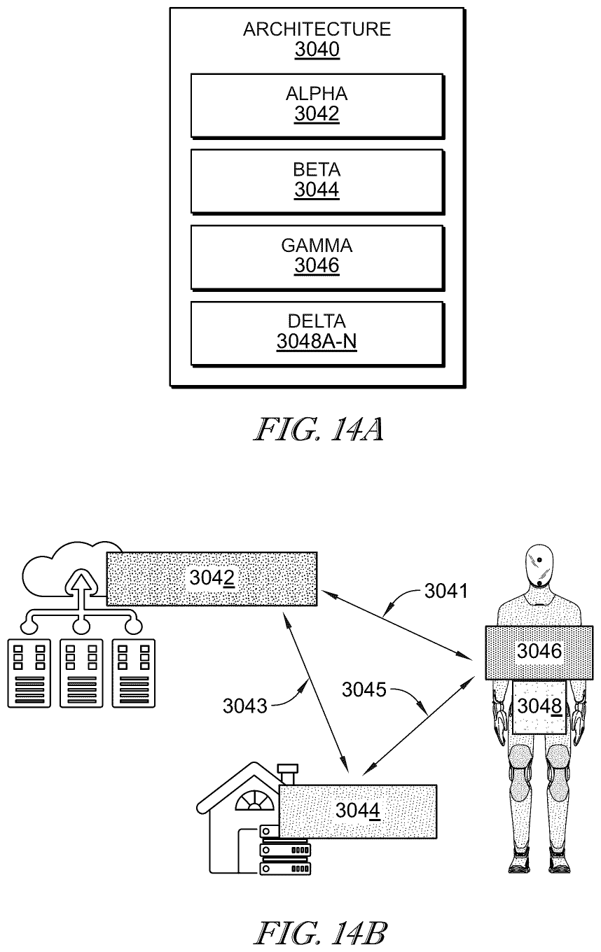

Referring now to FIG. 14A, a specific instance of a layered hierarchical cognitive architecture 3040 is presented as a non-limiting example that demonstrates the practical implementation of multi-tiered cognitive processing. This architecture can be understood as a concrete implementation of the general layered concept depicted in architecture 3020, wherein n=3 for the higher-level models in FIG. 12, creating a three-layer planning hierarchy. The architecture 3040 comprises four distinct functional layers: a large—alpha model 3042, a medium—beta model 3044, a small—gamma model 3046, and one or more delta models 3048A-N. Each layer may operate at a progressively faster timescale and a lower level of abstraction, and each can be tightly coupled with a specific tier of a cognitively inspired memory system, creating a “planning cascade” that is continuously informed by past experience and current context through temporal integration and memory consolidation mechanisms that mirror biological cognitive architectures.

To illustrate this intricate interplay, consider a home setting wherein the robot 1 receives a task: “I'm having guests over tonight, can you help me get ready?” The large alpha model 3042, functioning as the highest planner, initiates the process by accessing a long-term memory (LTM) that stores comprehensive knowledge accumulated over extended periods. The LTM represents a vast, persistent repository of the accumulated world knowledge of robot 1, which may be logically divided into three components, each serving distinct cognitive functions. First, the model queries a consolidated episodic memory, a “life log” implemented as a large-scale multimodal vector database, to retrieve past experiences related to “having guests.” This retrieval process may employ similarity metrics in high-dimensional embedding spaces to identify relevant memories. This might surface a memory from a week prior: an image of the user enjoying a specific type of cheese with a text annotation noting their positive comment, demonstrating the system's ability to learn user preferences from past interactions. Second, the model consults a semantic memory, or “world model,” which may be implemented as a knowledge graph (KG) of general facts (e.g., “cheese platters are appetizers,” “guests appreciate a tidy space”), providing ontological relationships and common-sense reasoning capabilities. Third, the model may access a procedural memory, such as a “skill library” of high-level action sequences (e.g., the steps for “tidying a room”), which encodes learned motor programs and action primitives. By synthesizing information from these three LTM components through a retrieval-augmented process that combines vector similarity search with graph traversal algorithms, the model 3042 may formulate a highly personalized, context-aware, and actionable strategic plan: (1) “Tidy the living room,” (2) “Prepare a cheddar cheese platter,” (3) “Dim the lights.” Periodically, a memory consolidation process, analogous to hippocampal function in biological systems, analyzes significant new experiences and transfers them from lower memory tiers into this permanent LTM, enabling lifelong learning for the humanoid robot 1 through experience replay and memory prioritization mechanisms.

The medium beta model 3044 may then receive a strategic objective, such as “Prepare a cheddar cheese platter” from the upper layer model 3042. This tactical planner's primary function involves maintaining task coherence over a medium timescale (minutes to hours), a role heavily dependent on medium-term memory (MTM) that bridges the gap between immediate perception and long-term planning. The MTM can be implemented as a session-specific “episodic buffer,” often using a temporary vector database for retrieval-augmented generation (RAG) that maintains contextual information throughout a task sequence. As the robot 1 begins the task by retrieving the cheddar, this event can be stored in the MTM with associated metadata including timestamps, object states, and success indicators. When the time arrives for the next step, the model queries this buffer to recall that “cheddar has been retrieved,” ensuring that the model proceeds logically to the next step, such as to “retrieve crackers” instead of repeating a step or losing the overall context of the “cheese platter” goal, thereby maintaining task continuity and preventing redundant actions. This mechanism can help prevent the “lost in the middle” problem that can affect models relying solely on a finite context window for long, multi-step tasks, particularly when interruptions or unexpected events occur. This model may also query a more localized semantic KG containing specific facts about the home environment, such as “the cutting board is stored in the third drawer to the left of the sink,” enabling efficient navigation and object retrieval based on spatial memory.

The small gamma model 3046, the short-horizon visuomotor planner, may receive a single, concrete instruction like “Retrieve crackers from the pantry.” This model's operation may rely on short-term memory (STM), also known as working memory, which maintains immediate sensory and motor information. STM can be implemented as a volatile, low-capacity, high-speed buffer that holds a finite history of the most recent sensor data—for example, the last 16 camera frames and the corresponding joint encoder readings, providing temporal context for motion generation. This brief but dense history allows the model 3046 to perceive the immediate dynamics of the environment, such as the speed and direction of its own hand moving toward the cracker box, enabling predictive control that anticipates future states. By processing this sequence of observations, the model can generate a smooth, predictive trajectory of end-effector poses that anticipates the immediate future, rather than just reacting to the present, incorporating forward models of object dynamics and robot kinematics. This enables fluid and precise short-horizon behaviors like aligning the gripper with the box's orientation, adjusting approach velocity based on distance, and pre-shaping the hand for optimal grasping configuration.

Finally, the delta models 3048A-N, comprising the lowest and fastest reactive layer, execute the trajectory from the small model with millisecond-level precision. The delta models represent the ultimate consumers of STM, operating in a tight, high-frequency control loop that may exceed 1000 Hz for certain reflexive responses. The delta models translate the kinematic targets from the small model into direct motor commands (e.g., joint positions and/or torques) by constantly referencing the most immediate proprioceptive and visual feedback stored in the STM, implementing feedback control algorithms that maintain stability and accuracy. This allows the robot 1 to exhibit micro-level reactivity that operates below conscious planning thresholds. For instance, if a tactile sensor in the fingertip registers unexpected contact with the edge of the shelf while reaching for the crackers, the delta model can instantaneously adjust the arm's torque profile to avoid a collision, a reflexive action that occurs too fast for the higher-level planners but remains essential for safe and robust physical interaction, demonstrating the value of hierarchical control with appropriate time-scale separation.

The practical deployment and dynamic interactions of the hierarchical AI model architecture 3040 are further illustrated in FIG. 14B, which demonstrates how distributed computing resources can be leveraged effectively. The hybrid cloud-edge strategy strategically distributes the cognitive and memory loads to optimize the system's overall performance, balancing factors such as latency, computational power, bandwidth utilization, and data privacy. The interaction begins when the robot, operating in the kitchen, receives the ambiguous voice command “I'm having guests over tonight, can you help me get ready?” Its onboard small model 3046 may recognize the speech and determine that the command requires long-horizon planning beyond its own capabilities, demonstrating metacognitive awareness of its own limitations. The model initiates a first instance of interaction 3041, a request to the large alpha model 3042. This request may contain the transcribed text along with a compressed video stream of the robot's current first-person view, utilizing efficient video codecs to minimize bandwidth requirements. The cloud-hosted large model 3042 may leverage its co-located LTM, and after its retrieval-augmented reasoning that may involve multiple database queries and inference steps, formulates a suggested strategy. Before proceeding, to ensure user alignment and safety, the model initiates a second instance of interaction 3041, this time sending a confirmation query back to the robot 1. The robot's onboard system 3046 receives this, synthesizes the text to speech using neural text-to-speech models and awaits the user's verbal response. Upon hearing “Yes, that sounds great,” the robot 1 may transmit this confirmation back to the large alpha model 3042 via a third instance of interaction 3041, completing the confirmation loop. Only upon receiving this explicit user approval does the large alpha model 3042 finalize its plan and initiate interaction 3043. A high-level directive may be sent to the medium beta model 3044 on the home server, including the now-confirmed task along with relevant context and constraints.

The medium beta model 3044 on the home server receives this strategic command through a secure, low-latency connection. The model queries its local, privacy-preserving knowledge graph of the home to find the locations of the items, utilizing spatial indexing and semantic search capabilities. The model may then begin to populate its medium-term memory buffer with the overall task goal, creating a persistent task context that survives across multiple action cycles. The model can formulate the first concrete, actionable step and initiates interaction 3045, sending a command to the robot's small model 3046 through an optimized protocol that may include compression and error correction. The robot's onboard small gamma model 3046 and delta models 3048 then take over, using their shared short-term memory to execute this specific, grounded instruction with real-time sensor feedback and adaptive control. Once the cheese is successfully retrieved, the small gamma model 3046 can send a confirmation message back to the home server via Interaction 3045, including status information and any relevant observations. The medium beta model 3044 may update its MTM to reflect that this step has finished and proceeds to formulate and send the next command (e.g., to retrieve the crackers), continuing this loop until the entire “cheese platter” task becomes complete, demonstrating effective task decomposition and execution monitoring. This distributed, message-passing protocol allows each layer of the hierarchy to operate at its optimal timescale, leveraging the appropriate memory system to achieve a task that would be intractable for any single monolithic model, while maintaining coherent behavior through structured communication.

Note that this described configuration represents a non-limiting exemplary embodiment that can be adapted to various deployment scenarios. The principles of the invention allow for numerous alternative deployment strategies tailored to specific operational requirements, hardware capabilities, and privacy considerations, enabling flexible system configuration. For instance, in a cloud-centric implementation optimized for simplicity of end-user hardware, the medium beta model 3044 and its associated medium-term memory could be co-located with the large alpha model 3042 in the cloud, effectively eliminating the need for a dedicated home server and reducing local infrastructure requirements. In this case, interaction 3043 becomes an internal, ultra-low-latency function call within the cloud data center, while interaction 3045 becomes a direct, higher-frequency communication from the cloud to the robot 1, sending tactical commands across the internet with appropriate quality-of-service guarantees. Conversely, a privacy-focused implementation might see the large alpha model 3042 and its long-term memory reside on a powerful home server alongside the medium beta model 3044, ensuring data sovereignty and compliance with privacy regulations. This configuration would maximize data security, as the vast majority of personal and environmental data would never leave the user's local network, with the cloud only being used for non-real-time, anonymized model training that preserves user privacy through differential privacy techniques.

Another alternative, driven by advances in edge computing, involves an enhanced autonomy model, wherein an exceptionally powerful onboard system-on-a-chip (SoC) allows the medium beta model 3044 and MTM to be hosted directly on the robot 1, leveraging hardware acceleration and optimized memory management. This would grant the robot the ability to complete complex, multi-step tasks entirely offline, relying on the cloud only for the most abstract strategic planning or periodic model updates. Furthermore, the nature of the models themselves remains mutable; the delta model layer 3048, instead of being a learned neural network, could be implemented as a classical, model-based controller such as a model predictive controller (MPC), which would receive goals from the small gamma model 3046 and calculate optimal torques based on a physical model of the robot's dynamics, providing guaranteed stability properties and interpretable control behavior. The advantage of the model hierarchy lies not in any single fixed arrangement, but in the synergistic co-design of a hierarchical cognitive AI architecture with a corresponding multi-tiered memory system, and the strategic, flexible distribution of these integrated layers across a hybrid computational infrastructure to optimize for competing demands of performance, privacy, and lifelong learning, enabling systems that can adapt to diverse operational requirements while maintaining consistent high-level behavior.

### vi. Third Model Architecture

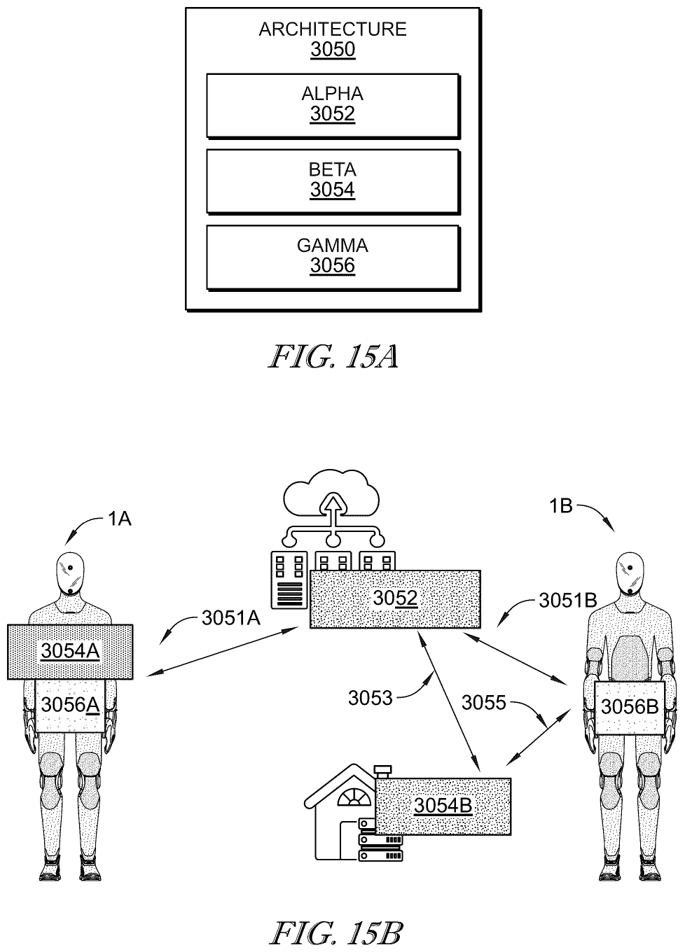

Referring now to FIG. 15A, an alternative instance of a hierarchical model architecture 3050 illustrates the flexibility of the disclosed framework through a streamlined three-layer configuration. This architecture features a flatter, more streamlined three-layer hierarchy, comprising a large alpha model 3052, a medium beta model 3054, and one or more small gamma models 3056. This architecture can be understood as another implementation of the general layered concept depicted in architecture 3020, wherein n=2 for the higher-level models in FIG. 12, or a specific implementation of the general layered concept depicted in architecture 3030, where n=1 for both layered VLMs 3032 and layered LLMs 3034. This configuration differs from architecture 3040 by omitting the small planning model layer, creating a more direct link between the medium-term tactical planner and the low-level action generation layer, reducing the number of abstraction levels and potentially decreasing overall system latency. This design proves particularly well-suited for tasks that require less fine-grained visuomotor planning and can be decomposed into a sequence of more direct motor skills, such as repetitive assembly tasks or structured interactions with known objects.

To illustrate this architecture, consider a scenario where a user requests, “Can you guide me through a 15-minute yoga routine?” The large alpha model 3052, acting as the strategic planner, may be triggered to process this high-level request. The model accesses its cloud-based long-term memory to formulate a personalized plan that considers user history, preferences, and physical capabilities. From its episodic memory, the model might retrieve records of the user's previous workout sessions, noting a preference for vinyasa-style flows and identifying any physical limitations or areas of focus. From its semantic memory, the model can access a knowledge graph detailing the anatomical benefits and correct forms of various yoga poses, including contraindications and modifications for different skill levels. From its procedural memory, the model may retrieve entire sequences or “sub-routines” for common flows like Sun Salutations, including timing, breathing patterns, and transition movements. The large model synthesizes this information to create a high-level plan, such as: “Start with a 5-minute warm-up including Cat-Cow poses, followed by three rounds of Sun Salutation A, and conclude with a 2-minute Savasana,” incorporating appropriate difficulty progression and rest periods.

This high-level plan then passes to the medium beta model 3054, which manages the real-time execution of the routine. This model can function as the real-time session manager or “yoga instructor,” maintaining awareness of elapsed time, pose transitions, and user fatigue levels. Its primary responsibility may include maintaining the coherence and timing of the routine, a task managed by its medium-term memory that tracks session state and progress. The medium-term memory can act as an episodic buffer for the current session, tracking which poses have been completed, the duration of holds, and the number of repetitions performed, ensuring smooth progression through the routine. Upon receiving the plan, the model initiates the first step, sending a command to the low-level execution layer with appropriate timing and transition parameters.

The small gamma models 3056 may then receive a discrete command from the medium model, such as “demonstrate Downward-Facing Dog.” The models function as highly optimized visuomotor policies, directly translating this command into a series of joint position and/or torque commands to move the robot's body into the correct pose through inverse kinematics calculations. The gamma models' actions are informed by their short-term memory, a continuous buffer of recent proprioceptive data that allows the models to execute the motion smoothly and maintain balance through dynamic stability control. The gamma models hold the pose for the duration specified by the medium model, potentially making micro-adjustments based on balance feedback, then await the next command, such as “transition to Plank pose.” This direct coupling of the medium model to the gamma models allows for a highly responsive and fluid execution of pre-defined motor skills, with minimal computational overhead between planning and execution layers.

Two distinct yet viable deployment configurations for the architecture 3050 are illustrated in FIG. 15B, highlighting the adaptability of the framework to different hardware and connectivity constraints while maintaining functional equivalence. The first deployment option, represented by the robot 1A on the left, exemplifies an enhanced autonomy model that maximizes onboard processing capabilities. In this configuration, the medium beta model 3054A may be co-located with the small gamma models 3056A on a powerful onboard computer, potentially utilizing specialized neural processing units for efficient inference. The initial interaction 3051A occurs when the robot sends the user's request for a yoga routine to the cloud-hosted large alpha model 3052, using compressed communication protocols to minimize bandwidth. The large model performs its long-term memory-informed planning and, in a subsequent instance of interaction 3051A, sends the entire 15-minute yoga plan back down to the robot, including all poses, timings, and transition instructions. From that point forward, the robot can execute the full routine autonomously without network dependency. The onboard medium beta model 3054A may sequence through the poses using its local medium-term memory, and the gamma models 3056A perform the movements, with no further need for communication with the cloud unless the user interrupts with a new, complex request that requires replanning, demonstrating robust offline operation capability. This configuration may be suitable for scenarios where network connectivity may be unstable or where extended periods of offline operation are desirable, such as in remote locations or during network outages.

The second deployment option, represented by the robot 1B on the right, illustrates a distributed intelligence model that leverages local network infrastructure. Here, the medium beta model 3054B resides on a local home server, while only the small gamma models 3056B run on the robot itself, which may have less powerful onboard computing hardware, reducing robot cost and power consumption. The process begins with interaction 3051B, where the robot relays the user's request to the alpha model 3052 through an optimized routing protocol. The large model, after formulating the workout plan using its comprehensive knowledge base, may send the plan to the home server via interaction 3053, utilizing the local network's higher bandwidth. The home server's medium beta model 3054B may then manage the session, sending one command at a time to the robot via interaction 3055, maintaining fine-grained control over execution. For example, the model would first send the “demonstrate Cat-Cow” command with specific parameters for speed and range of motion. The robot's gamma models 3056B would execute the pose, and upon completion, send a status update back to the home server via another instance of interaction 3055, including performance metrics and any detected anomalies. The home server would then update its medium-term memory and send the next command in the sequence, ensuring smooth progression through the routine. This approach reduces the computational burden on the robot but increases reliance on the local network, making it suitable for home environments with reliable Wi-Fi infrastructure. Both configurations effectively implement the same hierarchical cognitive architecture, demonstrating the invention's capacity to adapt to varying hardware ecosystems while maintaining its core functional principles of hierarchical planning and execution.

The two deployment options presented for architecture 3050 merely illustrate a broader spectrum of possible configurations that can be tailored to specific use cases and constraints. A privacy-centric model, for instance, could deploy the large alpha model 3052 and its long-term memory on the home server, co-locating the large model with the medium beta model 3054B, ensuring all personal data remains within the user's control. In this arrangement, all strategic and tactical planning, along with access to the robot's life-log, occurs entirely within the user's local network, significantly enhancing data security and compliance with privacy regulations such as GDPR. A thin-client robot model could be realized by hosting the small gamma models 3056B on the home server alongside the medium beta model 3054B, effectively turning the robot into a sensor-actuator shell that streams proprioceptive data and receives high-frequency motor commands over the local network, requiring minimal onboard processing but demanding exceptional network performance. This simplifies the robot's hardware but demands an exceptionally robust and low-latency Wi-Fi connection, potentially utilizing dedicated wireless channels or 5G technology. Such variations underscore that the fundamental hierarchical structure of the models and their corresponding memory systems provides a highly flexible framework, allowing for deployments that can be precisely tailored to the specific constraints and priorities of a given application, whether they be maximizing onboard autonomy, ensuring data privacy, or minimizing the hardware cost of the robot itself, while maintaining consistent behavioral capabilities across different configurations.

### vii. Fourth Model Architecture

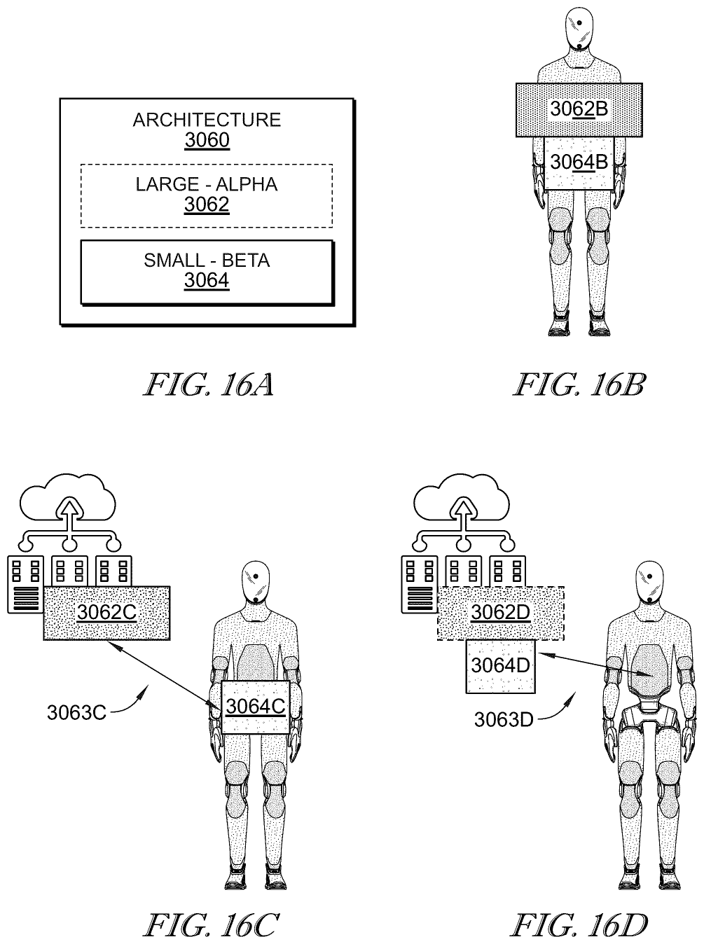

Referring now to FIG. 16A, a third instance of a hierarchical model architecture 3060 presents the flattest and most streamlined version of the hierarchy, comprising an optional large alpha model 3062 and one or more small beta models 3064. This two-layer architecture achieves maximum efficiency in tasks that are either highly procedural or can be directly addressed by a sophisticated, multi-skilled action model without requiring an intermediate tactical planning layer, reducing system complexity and response latency. The large model 3062 remains optional, allowing the AI system to scale down to a purely reactive, beta-driven mode for simpler, well-defined tasks where high-level planning would add unnecessary overhead.

To illustrate this architecture, consider a common household chore: sorting laundry. A user gives the command, “Please sort the laundry pile.” If the optional large model 3062 is utilized, the model acts as a high-level task initiator that provides context and constraints for the sorting task. The model leverages its long-term memory, specifically its semantic knowledge, to understand that “sorting laundry” typically means separating clothes by color (e.g., whites, darks, colors), fabric type, or washing requirements. The model may also access episodic memory to recall the user's specific sorting preferences, if any have been learned over time, such as separating delicates or sorting by family member. The large model's role does not involve generating a detailed plan, but rather providing an initial, contextually grounded command to the action layer, such as specifying sorting criteria and identifying the locations of sorted piles. The model sends a simple, high-level directive, such as “initiate color-based laundry sort,” to the small beta models 3064, along with any relevant parameters or constraints.

In this embodiment, the beta models 3064 can be powerful, self-contained visuomotor policies that have been extensively trained on the specific skill of sorting laundry through thousands of examples in simulation and real-world scenarios. The beta models may receive the high-level command, e.g., from large model 3062, and take full ownership of the task, demonstrating autonomous execution capability. For instance, using onboard vision encoders, the beta models can perceive the pile of clothes, identifying individual items through segmentation algorithms. The beta models can maintain the state of the task in their medium-term memory, which in this streamlined case might be a simple internal state machine or counter tracking the number of items sorted into each pile (whites, darks, colors), providing task progress awareness. For each piece of clothing, the beta models use their short-term memory—a buffer of the last few camera frames—to visually classify the item's color through learned color representations that account for varying lighting conditions. Based on this classification, the beta models may generate a series of action chunks: a sequence of motor commands to approach the item, grasp it with appropriate force based on fabric detection, move it to the correct destination pile following an optimized trajectory, and release it with proper placement. The beta models continue this perception-action loop until the laundry pile becomes empty, at which point the beta models signal task completion, demonstrating end-to-end task execution without high-level intervention.

Furthermore, the architecture 3060 can support a mode of operation where the large model 3062 is bypassed entirely, enabling direct task execution for well-learned behaviors. A user could give a more direct command like, “Sort these clothes.” A sophisticated beta model, equipped with its own integrated vision and text encoders, can be trained to recognize this command directly through multi-modal processing. The beta model maps the visual input of the laundry pile and the textual command directly to the initiation of its internal sorting behavior, demonstrating zero-shot task understanding. This beta model-only mode relies on the knowledge being implicitly “baked into” the neural network's weights through extensive prior training on diverse sorting scenarios. This allows for a highly reactive and efficient system that can perform familiar, well-trained tasks without the latency of consulting a large, external model, achieving response times suitable for real-time human-robot interaction.

A spectrum of deployment configurations for the architecture 3060 appears in FIGS. 16B, 16C, and 16D, illustrating its adaptability from fully autonomous to fully cloud-connected operation, covering the full range of deployment scenarios. FIG. 16B depicts a fully local deployment, representing the highest degree of autonomy and data privacy, suitable for applications requiring complete independence from external infrastructure. In this configuration, both the optional large model 3062B and the small beta models 3064B are executed on a powerful onboard computer, potentially utilizing edge AI accelerators for optimal performance. All memory systems, including a compact, distilled version of the long-term memory for the large model and the medium/short-term memory for the beta models, are hosted locally, ensuring zero network dependency. This robot can perform the entire laundry sorting task without any network connection, making the robot robust to connectivity outages and ensuring that all sensor data remains on the device, addressing privacy concerns and regulatory requirements.

FIG. 16C illustrates a hybrid cloud-local deployment, which balances the power of cloud computing with the responsiveness of edge execution, providing an optimal trade-off for many applications. Here, the large model 3062C and its extensive long-term memory reside in the cloud, while the small beta models 3064C run locally on the robot, leveraging both cloud intelligence and edge responsiveness. The interaction 3063C represents the communication between these tiers, utilizing adaptive protocols that can handle varying network conditions. For instance, the robot would send the initial “sort the laundry” request and a snapshot of the scene to the cloud, potentially using image compression and semantic extraction to minimize data transfer. The large model 3062C would process this and send back the initiating command with task parameters. The robot's beta models 3064C would then execute the entire sorting task locally, potentially sending progress updates or requests for help back to the cloud model if an anomaly is encountered, such as an unrecognized item or an ambiguous sorting decision.

FIG. 16D shows a fully cloud-based deployment, also known as a thin-client model, maximizing the use of cloud resources while minimizing robot hardware requirements. In this configuration, both the large model 3062D and the small beta models 3064D are hosted in the cloud, leveraging virtually unlimited computational resources. The robot itself primarily functions as a remote telepresence system, streaming its sensor data (vision, proprioception) to the cloud via the continuous, high-frequency interaction 3063D, potentially utilizing 5G or dedicated high-bandwidth connections. The cloud-based beta models process this data and stream low-level motor commands back to the robot's actuators, achieving remote real-time control. This configuration allows the robot to benefit from massive computational resources, enabling the use of the most powerful possible beta models with billions of parameters, but the configuration remains entirely dependent on a persistent, high-bandwidth, and low-latency network connection for basic functionality, making it suitable for controlled environments with guaranteed network infrastructure.

### viii. Further Alternative Embodiments

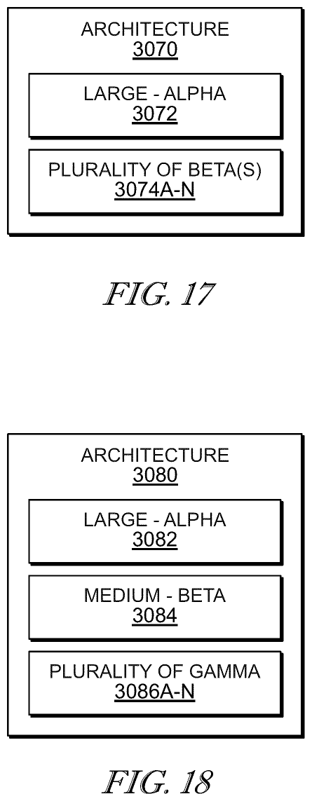

FIGS. 17-18 illustrate more alternative embodiments of the hierarchical models and deployment configurations, demonstrating the versatility and scalability of the disclosed approach. FIG. 17 presents a fourth specific instance of a hierarchical model architecture 3070 that explores homogeneous model architectures. This embodiment highlights the versatility of the disclosed models, demonstrating their capability to serve not only as low-level controllers but also as high-level reasoning and planning models when scaled appropriately. The architecture 3070 comprises a two-layer hierarchy consisting of a large alpha model 3072 at the top, and a plurality of specialized beta models 3074A-N at the bottom, creating a system where similar model architectures operate at different scales. This architecture may comprise models of different scales, creating a homogenous yet hierarchical system where architectural consistency simplifies training and deployment. A large alpha model at layer 3072 can be a substantial transformer-based policy, pre-trained on vast multimodal datasets of text, video, and robot state information, enabling the model to perform complex, end-to-end reasoning and task decomposition in a manner analogous to a traditional MLLM, or fine-tuned based on existing MLLMs, VLMs and LLMs, leveraging transfer learning from large-scale pre-training.

To illustrate this architecture, consider the task of setting a dining table for a meal. The user issues the command, “Set the table for two people.” The large alpha model 3072 (or MLLM, VLM) receives this instruction and processes it through its multi-modal understanding capabilities. Having been trained on extensive data including videos and descriptions of table setting, the model implicitly understands the components and spatial relationships of a formal place setting, including cultural variations and contextual adaptations. Its long-term memory, embedded within its network weights and potentially augmented by a retrieval mechanism, contains the semantic knowledge that a place setting includes a dinner plate, a fork, a knife, a spoon, and a water glass, along with their proper spatial arrangements. The model formulates a high-level plan, which in the context of a large alpha model (or MLLM, VLM) can be a sequence of generated sub-goals or action primitives that respect dependency constraints. For this task, the model might decompose the goal into: “retrieve two dinner plates,” “place plates,” “retrieve two sets of cutlery,” “place cutlery,” and so on, ensuring proper sequencing and resource allocation.

These sub-goals then pass down to the plurality of small beta models 3074A-N, each optimized for specific action domains. This layer can be composed of multiple, specialized beta models, each fine-tuned for a specific domain of action, creating a distributed execution layer with domain expertise. For example, beta model 3074A could be a “locomotion specialist,” responsible for navigating from the dining room to the kitchen cabinets, incorporating path planning and obstacle avoidance. Beta model 3074B could be a “grasping specialist,” fine-tuned for the delicate manipulation of fragile items like plates and glasses, with force control and slip detection capabilities. Beta model 3074C could be a “placement specialist,” skilled in precisely arranging items on the table according to formal dining conventions. The large alpha model 3072 acts as an orchestrator, activating the appropriate specialized beta model at each step of the plan through a routing mechanism. Each specialist beta model relies on its own short-term memory buffer of sensorimotor data to execute its task with high precision and reactivity, adapting to local variations and disturbances.

The deployment of architecture 3070 can be adapted to various needs through flexible resource allocation. In a local deployment, a powerful onboard computer could host the large alpha model 3072 and all specialized beta models 3074A-N, enabling full autonomy and offline operation. A hybrid deployment remains possible, where the computationally heavy, large alpha model 3072 resides in the cloud or on a home server, while the latency-sensitive specialist beta models 3074A-N run on the robot's local hardware, balancing computational requirements with response time constraints. The large alpha model would stream sub-goal commands to the local beta models for execution through an efficient communication protocol. Finally, a cloud deployment could host the entire architecture remotely, with the robot acting as a thin client, streaming all sensor data up and receiving motor commands for all actuators back from the cloud-hosted specialist beta models, maximizing computational capabilities at the cost of network dependency.

Referring now to FIG. 18, a fifth specific instance of a hierarchical model architecture 3080 expands upon the concept of a model-based system by creating a deeper, three-layer hierarchy that provides finer control granularity. The architecture comprises a large alpha model 3082, a medium beta model 3084, and a plurality of gamma models 3086A-N. This structure allows for an even finer-grained decomposition of tasks and demonstrates a fully-realized planning cascade built from different scales of action-oriented models, with each layer contributing specific expertise.

To illustrate this architecture, consider a more complex, long-horizon chore: watering all the houseplants in a home. The user gives a general command, “The plants look thirsty, please water them.” The large alpha model 3082 at the top of the hierarchy initiates the plan, demonstrating high-level scene understanding and task planning. The model functions as the strategic planner, accessing its long-term memory to identify all entities classified as “houseplants” within its semantic map of the home through object recognition and spatial memory. The model might identify the “ficus in the living room,” the “succulent on the windowsill,” and the “fern in the bathroom,” each with associated care requirements and watering schedules. Its output consists of a high-level strategic sequence of objectives, such as: “water ficus,” then “water succulent,” then “water fern,” optimized for efficiency and plant care requirements.

This sequence passes to the medium beta model 3084, which acts as the tactical planner responsible for resource management and step sequencing. The medium beta model takes a single objective, such as “water ficus,” and breaks the objective down into a more concrete, ordered sequence of actions to achieve it, considering tool availability and environmental constraints. This involves querying its medium-term memory and local knowledge graph to determine the state of tools (e.g., “the watering can is in the utility closet,” “the watering can is currently empty”), enabling efficient tool use and preparation. The medium beta model then generates a tactical plan: (1) “go to utility closet,” (2) “retrieve watering can,” (3) “go to kitchen sink,” (4) “fill watering can,” (5) “go to living room,” (6) “pour water into ficus plant,” with each step annotated with expected duration and resource requirements.

Each of these tactical steps then sends, one by one, to the lowest layer, the plurality of gamma models 3086A-N, which handle the fine-grained motor control. This layer, as in the previous example, can be composed of specialized gamma models for locomotion, grasping, and precise pouring, each optimized for their specific motor control domain. For the command “fill watering can,” the locomotion gamma model would navigate to the sink using SLAM and path planning, the grasping gamma model would manipulate the faucet handle with appropriate force control, and another manipulation gamma model would hold the can steady, using visual and auditory feedback from its short-term memory to stop when the can becomes full, demonstrating multi-sensory integration for task completion. This deep hierarchy allows the robot to manage complex, multi-location, multi-tool tasks by systematically reducing a high-level, abstract goal into a series of precise, reactive motor behaviors, with each layer contributing its specialized expertise to achieve robust task completion.

In certain embodiments, the hierarchical architecture comprises a two-tier model system, wherein a first model operates as the highest-level model and a second model operates as the lowest-level model. The first model comprises a large-scale model architecture, while the second model comprises a smaller-scale architecture relative to the first model. The relative size comparison between models may be determined based upon one or more of the following parameters: number of model parameters, context window size, number of attention heads, number of neural network layers, dimensionality of input and output vectors, and computational complexity metrics. By way of illustrative example, the first model may be configured with a context window ranging from approximately four thousand to one million tokens, a parameter count ranging from approximately five billion to two trillion parameters, and a processing speed ranging from approximately one microhertz to ten hertz. The second model may be configured with a context window ranging from approximately one hundred to five thousand tokens, a parameter count ranging from approximately ten thousand to five billion parameters, and a processing speed ranging from approximately one hertz to ten kilohertz. In this two-tier configuration, the first model generates high-level control outputs comprising one or more of currents, torques, positions, rotations, and position or rotation deltas for the robotic system as a whole, while the second model generates low-level control outputs comprising one or more of currents, torques, positions, rotations, and position or rotation deltas for individual actuators or actuator groups.

In modified embodiments of the two-tier architecture, the system may implement asymmetric processing distributions wherein the first model operates on a cloud-based or edge computing infrastructure while the second model executes locally on the robotic platform. Alternative implementations may feature bidirectional feedback loops between the two tiers, allowing the lower-level model to inform and update the higher-level model's decision-making processes based on real-time sensor feedback and actuator state information. The two-tier system may further incorporate adaptive load balancing mechanisms that dynamically adjust the computational distribution between tiers based on available processing resources, network latency, and task urgency requirements.

In alternative embodiments, the hierarchical architecture comprises a three-tier model system including a first model operating as the highest-level model, a second model operating as a mid-level model, and a third model operating as the lowest-level model. The first model comprises the largest computational architecture, the second model comprises an intermediate computational architecture, and the third model comprises the smallest computational architecture. The first model may be configured with a context window ranging from approximately eight thousand to five million tokens, a parameter count ranging from approximately fifty billion to two trillion parameters, and a processing speed ranging from approximately one hundred microhertz to one hundred millihertz. The second model may be configured with a context window ranging from approximately one thousand to fifty thousand tokens, a parameter count ranging from approximately five billion to fifty billion parameters, and a processing speed ranging from approximately one hundred millihertz to ten hertz. The third model may be configured with a context window ranging from approximately one hundred to five thousand tokens, a parameter count ranging from approximately fifty thousand to five billion parameters, and a processing speed ranging from approximately one hertz to ten kilohertz.

In this three-tier configuration, the first model generates system-level control outputs for the entire robotic platform, the second model generates regional control outputs for defined regions of the robot such as upper body region or lower body region, and the third model generates actuator-specific control outputs for individual actuators within said regions. Variations of this architecture may implement hierarchical attention mechanisms wherein each tier maintains selective attention to outputs from adjacent tiers, enabling more efficient information flow and reduced computational overhead. The three-tier system may also incorporate tier-skipping connections that allow direct communication between non-adjacent levels during critical operations or emergency responses, bypassing intermediate processing when rapid action is required.

In further embodiments, the hierarchical architecture comprises a one-to-many configuration including a single high-level model and a plurality of low-level models. The high-level model may be configured with a context window ranging from approximately four thousand to one million tokens, a parameter count ranging from approximately five billion to two trillion parameters, and a processing speed ranging from approximately one microhertz to ten hertz. Each of the plurality of low-level models may be configured with a context window ranging from approximately one hundred to five thousand tokens, a parameter count ranging from approximately ten thousand to five billion parameters, and a processing speed ranging from approximately one hertz to ten kilohertz. In this configuration, the high-level model determines general positions and rotations based on long-horizon goals, while each of the plurality of low-level models is assigned to a specific actuator group or individual actuator, generating specific control signals including currents, torques, positions, and rotations for their respective actuators. Enhanced versions of this architecture may implement dynamic model spawning wherein the number of low-level models varies based on task complexity and available computational resources. The system may further incorporate model pooling strategies where low-level models are dynamically allocated from a shared pool to different actuator groups based on current operational requirements, enabling more efficient resource utilization.

In certain embodiments, the hierarchical architecture incorporates a Multimodal Large Language Model as the highest-level model in conjunction with a plurality of specialized models at the lowest level. The Multimodal Large Language Model may be configured with a context window ranging from approximately four thousand to one million tokens, a parameter count ranging from approximately five billion to two trillion parameters, and a processing speed ranging from approximately one microhertz to ten hertz. Each of the specialized models may be configured with a context window ranging from approximately one hundred to five thousand tokens, a parameter count ranging from approximately ten thousand to five billion parameters, and a processing speed ranging from approximately one hertz to ten kilohertz.

The Multimodal Large Language Model processes long-horizon goals and decomposes them into specific sequential steps required for goal achievement. Each specialized model is assigned to specific actuator groups or individual actuators, generating precise control outputs including currents, torques, positions, and rotations. Advanced implementations may incorporate continuous learning mechanisms wherein the Multimodal Large Language Model updates its internal representations based on successful task completions and failures, enabling improved performance over time. The architecture may also feature multimodal fusion layers that combine visual, auditory, tactile, and proprioceptive inputs at various stages of processing, enhancing environmental awareness and decision-making capabilities.

In additional embodiments, the hierarchical architecture comprises a hybrid system incorporating a Multimodal Large Language Model as the highest-level model, a Large Language Model as a mid-level model, and one or more specialized models at the lowest level. In alternative configurations, the positional hierarchy of the Multimodal Large Language Model and Large Language Model may be reversed. The Multimodal Large Language Model may be configured with a context window ranging from approximately four thousand to one million tokens, a parameter count ranging from approximately five billion to two trillion parameters, and a processing speed ranging from approximately one microhertz to ten hertz. The Large Language Model may be configured with a context window ranging from approximately one thousand to fifty thousand tokens, a parameter count ranging from approximately five billion to fifty billion parameters, and a processing speed ranging from approximately one hundred millihertz to one hundred hertz. The specialized models may be configured with a context window ranging from approximately one hundred to five thousand tokens, a parameter count ranging from approximately ten thousand to five billion parameters, and a processing speed ranging from approximately one hertz to ten kilohertz.

In this configuration, the Multimodal Large Language Model processes visual and multimodal inputs to detect environmental objects and determine complex long-horizon goals. The Large Language Model performs natural language processing tasks including speech-to-text conversion. The specialized models generate rapid actuator-specific control signals responsive to environmental conditions. Modified versions may implement cross-modal attention mechanisms that enable the Large Language Model to directly influence the Multimodal Large Language Model's visual processing based on linguistic context, and vice versa, creating a more integrated cognitive architecture. The system may further comprise alternative hierarchical configurations including various combinations of Multimodal Large Language Models and specialized models. One variation comprises a large Multimodal Large Language Model, a medium Multimodal Large Language Model, and one or more specialized models, wherein the Multimodal Large Language Models process multimodal inputs at different levels of abstraction. Another variation comprises a large Multimodal Large Language Model, a medium Multimodal Large Language Model, a small Multimodal Large Language Model, and one or more specialized models, providing four-tier multimodal processing. Additional configurations may comprise multiple layered Multimodal Large Language Models of uniform or varying sizes, coupled with one or more specialized models, enabling parallel multimodal processing pathways. Further variations may comprise multiple layered Vision-Language Models of uniform or varying sizes, coupled with one or more specialized models, optimized for visual-linguistic task decomposition. Each architectural variation is configurable based on specific robotic control requirements, computational constraints, and real-time processing demands of the target application.

In various embodiments, the hierarchical architectures described herein may incorporate dynamic reconfiguration capabilities that allow real-time modification of the model hierarchy based on operational conditions. The system may implement automatic tier insertion or removal, wherein intermediate processing layers are dynamically added or removed based on task complexity assessment. For instance, when encountering novel or complex scenarios, the system may automatically insert additional processing tiers between existing levels to provide more granular control decomposition. The architectures may further incorporate adaptive model sizing mechanisms that dynamically adjust model parameters, context windows, and processing speeds based on available computational resources and task requirements. This may include model compression techniques such as quantization, pruning, or knowledge distillation applied selectively to different tiers based on performance requirements. The system may also implement hot-swapping capabilities, allowing individual models within the hierarchy to be replaced or updated without interrupting ongoing operations, enabling continuous system improvement and maintenance.

Alternative embodiments may implement the hierarchical architectures in distributed or federated configurations across multiple physical or virtual computing platforms. In such implementations, different tiers of the hierarchy may be distributed across cloud servers, edge computing devices, and local robotic processors, with sophisticated synchronization and communication protocols ensuring coherent operation. The system may implement consensus mechanisms between distributed model instances to ensure consistent decision-making across the distributed hierarchy. Federated learning approaches may be employed wherein multiple robotic systems share learned parameters and experiences while maintaining operational independence. This may include privacy-preserving techniques such as differential privacy or secure multi-party computation to protect sensitive operational data while enabling collective learning. The distributed architecture may also implement redundant model instances at critical tiers, providing failover capabilities and ensuring continuous operation even in the event of individual component failures.

The hierarchical architectures may be adapted for specific robotic domains through specialized model configurations and training procedures. For industrial robotics applications, the hierarchy may emphasize precision and repeatability, with specialized models trained on manufacturing-specific datasets and optimized for deterministic behavior. For service robotics, the architecture may prioritize human interaction capabilities, with enhanced natural language processing and social behavior modeling integrated throughout the hierarchy. In medical or surgical robotics applications, the system may implement additional safety layers and verification mechanisms between hierarchical tiers, ensuring that all control outputs meet stringent safety requirements. For autonomous vehicle applications, the hierarchy may incorporate specialized models for traffic prediction, path planning, and collision avoidance, with real-time sensor fusion capabilities integrated at multiple levels. Agricultural robotics implementations may feature models specialized for crop recognition, soil analysis, and weather adaptation, with seasonal learning mechanisms that adjust behavior based on environmental cycles.

Various embodiments may implement hardware-specific optimizations tailored to the computational platforms available on the robotic system. For systems equipped with specialized neural processing units or tensor processing units, the model hierarchy may be optimized to leverage these accelerators, with specific layers or operations mapped to hardware-accelerated functions. The architecture may implement mixed-precision computing strategies, utilizing different numerical precisions at different tiers based on accuracy requirements and hardware capabilities. For resource-constrained robotic platforms, the system may implement aggressive model compression techniques including binary or ternary quantization for lower-tier models while maintaining higher precision for critical high-level decision-making models. The architecture may also feature hardware-aware neural architecture search capabilities that automatically optimize model structures based on the specific computational resources available on the target platform.

The hierarchical architectures may incorporate various learning and optimization mechanisms that enable continuous improvement of system performance. This may include online learning capabilities wherein models at different tiers adapt their parameters based on real-time feedback, with learning rates and update frequencies tailored to each tier's operational characteristics. The system may implement curriculum learning strategies, gradually increasing task complexity as the hierarchy develops competency in simpler operations. Meta-learning approaches may be employed to enable rapid adaptation to new tasks or environments, with higher-tier models learning to generate effective initialization parameters for lower-tier models when encountering novel situations. The architecture may also feature automated hyperparameter optimization mechanisms that continuously tune model configurations based on performance metrics, ensuring optimal operation across varying conditions.

### 5. Whole Body Controller

The whole body controller 1550 may be embodied as any combination of hardware, software, or circuitry for receiving information from the behavior manager 1350 or the local AI system 1470 and translating high-level commands into coordinated full-body motion. The whole body controller 1550 may thereafter send the information to other components of the compute 1000, ensuring synchronized control across all robot subsystems. For example, the whole body controller 1550 may transmit joint torque data, which represents data pertaining to rotational forces exerted at “joints” of the humanoid robot 1, to the controllers 1600, implementing torque limits and safety margins. The whole body controller 1550 may implement various control strategies including computed torque control, impedance control, and admittance control, selecting the appropriate strategy based on task requirements and environmental interactions, the whole body controller 1550 may be omitted and/or consumed by one or more models (e.g., RL trained models) that are contained within the local AI system 1470, providing end-to-end learned control.

The controllers 1600 may be embodied as any combination of hardware, software, and/or circuitry for transmitting joint torque data to the actuators 1.2.4, e.g., to extend and retract parts (such as arms, hands, fingers of the humanoid robot 1), with precise timing and coordination. The controllers 1600 may also infer joint torque and angle data received from other sensors 1.2.8, such as IMUs mounted on a given “body part,” providing redundant sensing for increased reliability. In some embodiments, the joint torque and angle data may be measured using rotary position sensors, optical reflection, or other methods, with sensor fusion algorithms combining multiple measurements for improved accuracy. The whole body controller 1550 may also incorporate advanced control strategies, such as passivity-based control or adaptive control, to ensure stability and robustness in the presence of uncertainties or external disturbances, automatically adjusting control parameters based on detected environmental conditions, the controllers 1600 may be omitted and/or consumed by one or more models (e.g., RL trained models) that are contained within the local AI system 1470, enabling direct neural control of actuators.

### 6. Other

Other components 1650 of the compute 1000 may include components not discussed above relative to the compute 1000, such as power management modules (e.g., to manage battery pack health, manage power usage profiles, implement predictive power optimization, etc.) and calibration modules (e.g., to ensure that actual kinetic movements of the humanoid robot 1 align with the expected kinetic movements determined based on calculations), maintaining system accuracy over time. The humanoid robot 1 may include other components 1.2.18, which can encompass components that do not necessarily fall within the aforementioned mechanical and electrical architecture 1.2, or compute 1000. For example, the other components 1.2.18 may include safety systems and mechanisms, emergency override systems, or ports for connecting peripheral devices, thermal management systems for heat dissipation, and diagnostic interfaces for maintenance and troubleshooting.

d. Interaction Between Components of the Computing Architecture

FIG. 10 depicts interactions between components of the humanoid robot 1 during its operation, illustrating the complex information flow and control hierarchy. Upon startup of the humanoid robot 1, the humanoid robot 1 may be in a standby mode or may otherwise remain idle in an initial position (e.g., standing, sitting, lying down, etc.), with all systems performing self-diagnostics and initialization procedures. The robot 1 may initialize and activate its sensors 1.2.8 and obtain data in relation to the environment and surroundings of the robot 1, as well as positional data, audiovisual data, and the like, establishing baseline measurements and calibrating sensor offsets. The movement controller 1302 may obtain data from its environment using the perception system 1420, while understanding the location and position of the robot 1 within said environment through localization algorithms and map building.

The environmental data, along with the robot data, can be fed into: (i) the local AI system 1470 and (ii) the behavior manager 1350, creating parallel processing pathways for different aspects of robot control. The local AI system 1470 can then convert speech to text in order to obtain long-horizon goals, wherein said local AI system 1470 can subdivide these long-horizon goals into one or more sub-goals or tasks through hierarchical task decomposition. The local AI system 1470 can then check with the behavior manager 1350 to confirm that the robot 1 maintains the correct state for performing the first sub-goal or task, ensuring preconditions are met. Once the state of the robot 1 becomes confirmed or the state of the robot 1 changes to be in the right state, the local AI system 1470 can determine the movements and actions to perform for a given specified task, generating motion plans that satisfy kinematic and dynamic constraints. For instance, using a Helix architecture, the local AI system 1470 (acting as an S2 subsystem) may process the task and sensor data to generate information that is provided to a semantic latent vector, creating a compressed representation of the task context. This information passes through the said latent vector and into a reactive policy (an S1 subsystem), which operates at high frequency for real-time control. The reactive policy (S1) may then communicate the detailed movement or action information to the whole body controller 1550, which in turn generates joint torque data and transmits the data to the controllers 1600 to effect activity in the actuators 1.2.4 and cause the movement or action to be performed, completing the control loop from perception to action.

Each of the interacting components may provide feedback information to each other as the movements or actions are being performed, creating a robust closed-loop control system. For example, the perception system 1420 may relay an indication to the movement controller 1302 that a given task has completed based on audiovisual data received during the performance of an action or movement, enabling task monitoring and verification. As another example, the behavior manager 1350 may be in continuous communication with the whole body controller 1550 to ensure that the movement and positioning of the robot 1 remain as instructed and/or planned by the local AI system 1470, providing real-time corrections for disturbances. As yet another example, the local AI system 1470 may continuously receive data from the perception system 1420, the movement controller 1302, the behavior manager 1350, and the whole body controller 1550 and use the data to refine and optimize the currently executing model given present configurations, conditions, and constraints, implementing online learning and adaptation, the movement controller 1302, behavior manager 1350, perception system 1420, whole body controller 1550, and/or controllers 1600 may be omitted or replaced in alternative embodiments, depending on the specific architectural choices and control paradigms employed.

### E. Model Training and Deployment

The above disclosed hierarchical AI architectures can be trained and deployed in an end-to-end fashion to control the complex, high-degree-of-freedom movements of humanoid robots 1, 2700A-X, enabling seamless integration of perception, planning, and control. The BAM for humanoid robots can ingest multimodal sensory inputs, which may comprise a combination of real-time visual data from onboard cameras, proprioceptive state information from joint encoders and inertial measurement units, force-torque sensor readings from end effectors, and natural language instructions, creating a comprehensive understanding of both the robot's state and task requirements. The BAM can output a continuous sequence of low-level robot control commands, or “actions,” that can be utilized by the robot 1, 2700A-X to directly specify joint torques, velocities, or target positions or deltas thereof, providing smooth and coordinated motion. The disclosed BAM offers several advantages over existing robotic control approaches, including, but not limited to: zero-shot generalization capabilities that enable the robot to perform novel tasks and interact with unseen objects without task-specific training through learned representations in high-dimensional feature spaces that capture underlying task structure and object affordances, direct continuous control over high-dimensional action spaces to produce fluid and precise motion that respects physical constraints and optimizes energy efficiency, inherent capabilities for multi-robot collaboration through shared world models that maintain geometric and semantic consistency across robot instances enabling coordinated team behaviors, and a design that remains commercially ready and fully scalable for deployment across fleets of robots 1, 2700A-X with centralized training and distributed deployment capabilities.

a. Model Training

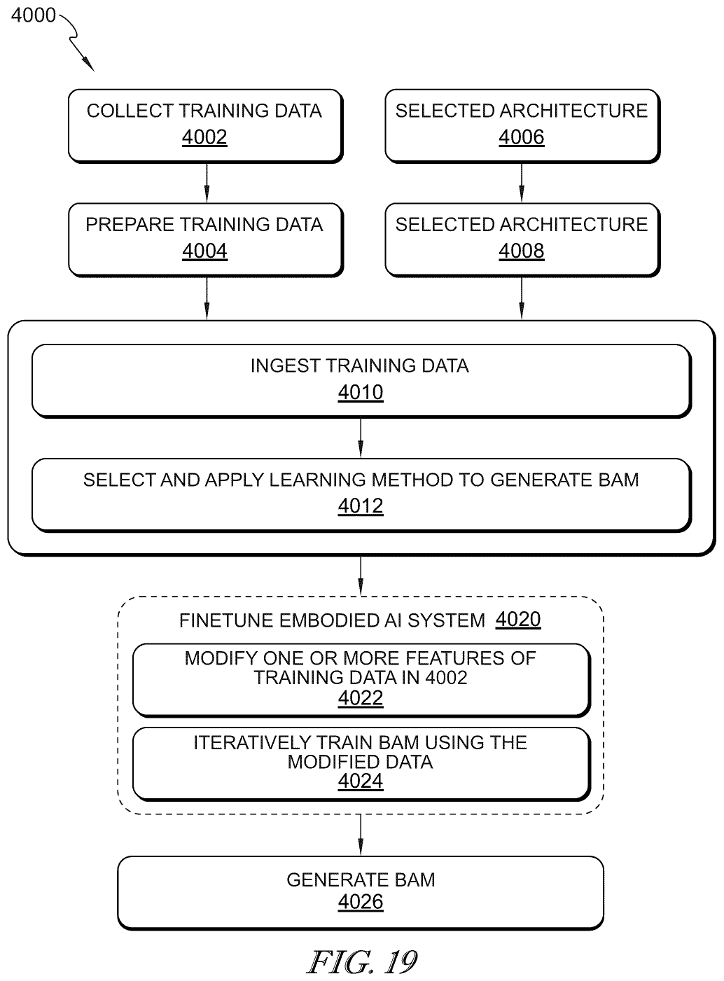

FIG. 19 illustrates a general process for generating the BAM through iterative optimization and validation cycles that progressively refine model performance. As discussed above in connection with FIGS. 14-18, the process may start with the selection or generation of the deployment configuration determining computational resource allocation, the architecture defining model connectivity and information flow, and the model types specifying inductive biases and learning paradigms in steps 4006 and 4008. An example of the selections and/or generations that may be performed may include: (i) selecting a deployment configuration where a medium alpha model 3054 runs on a first GPU installed within the robot's torso 1, 2700A-X with specific memory and bandwidth allocations, and a small beta model 3056 runs on a second GPU installed within the robot's torso 1, 2700A-x with optimized inference settings, and (ii) obtaining a MLLM, VLM or LLM that was trained on internet data using a cross-entropy loss function and outputs discrete data, along with generating a cross-attention encoder-decoder transformer that was trained on robot teleoperation demonstrations using a regression loss function and outputs continuous floating-point numbers representing control signals with appropriate normalization and scaling.

Along with the selection or generation of these elements forming the model foundation, the designer may need to process, refine, structure, and enrich the collected training data 4002 through comprehensive preprocessing pipelines in step 4004. This preprocessing stage may involve annotation and labeling with semi-automated tools, where video data undergoes segmentation into distinct, meaningful segments using shot detection algorithms and temporal coherence analysis, each marked with timestamps aligned across sensors through hardware synchronization or software time alignment. These segments can then be assigned detailed natural language descriptions generated by vision-language models that explain the actions and interactions occurring within them, including object states, contact events, and task progress indicators, providing rich semantic annotations for supervised learning. The entire task trajectory may also be labeled with its final outcome through automated evaluation, such as “success” with task completion metrics including time, accuracy, and efficiency measures, or “failure” with diagnostic information including failure modes and recovery strategies, to allow the model to learn from both positive and negative examples through contrastive learning that distinguishes successful from unsuccessful behaviors. Other preprocessing techniques may include random sampling with stratification to create manageable training sequences from long demonstrations while preserving task diversity across different scenarios and difficulty levels, and trajectory filtering using quality metrics to remove low-quality or irrelevant data, such as trajectories with significant occlusions detected through visibility analysis using depth maps and segmentation masks, or noisy sensor readings identified through statistical outlier detection using methods such as

Other processing, refining, or structuring of the training data may include or exclude: (i) event-triggered slicing of multi-sensor streams (contact/fault/state-change) with precise temporal alignment, (ii) calibration handling (intrinsic/extrinsic updates with distortion correction, drift compensation through sensor fusion), (iii) quality control and curation (de-duplication using perceptual hashing, outlier removal with statistical methods, missing-data imputation through interpolation, checksum validation for data integrity), (iv) signal cleanup (denoising/smoothing with Kalman filtering, detrending removing systematic biases, artifact suppression eliminating sensor glitches), (v) event/binning at byte or packet level (burst or keyframe-grouped bins) for efficient storage, (vi) kinematic reconstruction (forward/inverse kinematics solving joint configurations, twist/wrench computation for velocity and force), (vii) derived signals (contact state from force thresholds, center-of-pressure from force distribution, occupancy/height maps from depth sensors, SDFs from point clouds, cost/reward traces from task objectives), (viii) sequence/trajectory assembly with teacher-forcing or rollout annotations for supervised learning, (ix) self-supervised target generation (masking/denoising targets for reconstruction, contrastive pairs/triplets for metric learning, next-step prediction for dynamics modeling, temporal order/reversal for sequence understanding), (x) weak/explicit labeling (heuristics from domain knowledge, simulation providing perfect labels, programmatic rules encoding priors, human annotation for ground truth), (xi) data augmentation and domain randomization (spatial/photometric/temporal/viewpoint/dynamics variations; noise injection, cutout/mixup for robustness), (xii) balancing and sampling strategies (class/scene balance addressing skew, curriculum sampling with increasing difficulty, hard-negative mining focusing on errors), (xiii) compression and quantized feature caches (e.g., NF4/FP8/INT8) for storage/throughput optimization, (xiv) privacy/security filtering (anonymization removing identifiers, PII/PHI redaction for compliance, access-control tagging for permissions), (xv) metadata/provenance attachment (sensor IDs for tracking, calibration versions for reproducibility, environment/task/policy tags for organization), (xvi) retrieval indices and memory tables for RAG-style conditioning enabling knowledge grounding, (xvii) teacher/assistant signal preparation for distillation (logits as soft targets, intermediate features for matching, attention maps for structure transfer), (xviii) dataset partitioning (train/val/test with no leakage, temporal/domain/robot splits for generalization evaluation), (xix) online/streaming ingestion with back-pressure and late-bound labeling for continuous learning, (xxi) any combination thereof creating comprehensive pipelines, (xxii) any processing, refining, or structuring disclosed in a paper that is incorporated herein by reference advancing best practices, and/or (xxiii) any processing, refining, or structuring that becomes apparent to one of skill in the art.

Data augmentation may also be employed to enhance the dataset with temporal and sensory context. This can include creating a vision memory by providing the model with a sequence of recent video frames, rather than a single instantaneous frame, to improve its understanding of dynamic scenes through temporal coherence modeling. Similarly, a state history, comprising a temporal window of past robot or human tracking states, can be used to provide context for generating smoother and more reactive motions through trajectory smoothing algorithms. The input observations may also be augmented by integrating force feedback data from tactile or force sensors, providing the policy with a sense of touch to better modulate its physical interactions through haptic feedback processing. Furthermore, when training with mixed datasets of human and robot data, data alignment techniques may be used. This can involve removing robot-specific state information or randomly masking sensor data fields that are not present in the human data, which forces the model to learn from the shared data streams and improves its ability to generalize across different embodiments through cross-embodiment transfer learning.

The core process of creating the BAM begins with ingestion of the training data in step 4010. Said ingestion may focus on data modifications that alter the prepared training data into information that can be consumed in the process of training the BAM, wherein said data modifications include: (i) tokenization/discretization into discrete IDs (e.g., BPE/WordPiece/Unigram for text; vector-quantized codes via VQ-VAE/RVQ, product/k-means codes for images/audio/features); (ii) patchification/tiling of images or video (fixed-size patches/tubelets) and linear projection to embedding dimension; (iii) framing/windowing of time-series or audio with fixed hop sizes; (iv) padding/truncation and bucketing to normalize sequence lengths, with optional special markers (CLS/SEP/BOS/EOS); (v) feature scaling/normalization (per-channel mean-std, min-max, whitening, log scaling, clipping to valid ranges); (vi) rate conversion/resampling and time alignment/interpolation to common sampling grids; (vii) precision casting/quantization of inputs (e.g., float32→bfloat16/float16 or INT8) for compute compatibility; (viii) embedding/projection layers that map continuous inputs (pixels, forces, IMU, tabular fields) to fixed-width vectors; (ix) positional/temporal encodings (sinusoidal/learned, rotary/relative) appended or fused with inputs; (x) coordinate-frame canonicalization (e.g., transforming sensor/EE frames to a world frame; centering/orienting 3D data; unit-cube/sphere normalization); (xi) serialization to tensor layouts for the backbone (e.g., (B, T, D), (B, C, H, W), contiguous memory; ragged/sparse tensors as needed); (xii) graph construction for GNNs (node-feature matrices, edge index/adjacency in COO/CSR; batching with graph IDs); (xiii) 3D representation building (voxel/TSDF grids, occupancy/SDF fields, ray bundles for NeRF, point-cloud subsampling/quantization, mesh→point/graph conversion, normal maps); (xiv) audio representations (STFT/mel spectrograms, MFCCs, magnitude/phase splits) normalized to model-specific ranges; (xv) label/target encoding into model-readable forms (class indices, one-hot/multi-hot, normalized boxes/segments, heatmaps/keypoints, regression tensors); (xvi) masking/corruption transforms that generate masked inputs for masked-modeling objectives (e.g., MLM/MAE span masks) while preserving model-expected shapes; (xvii) multimodal fusion prep (time-locking modalities, length-matching via padding/resampling, channel/time concatenation, or projection into a shared embedding space); (xviii) sparsity formats (structured/unstructured indices) for sparse backbones or memory-efficient loaders; (xix) value/unit harmonization (unit conversions, bias/offset removal) to match learned scaling; (xx) sample/chunk packaging into fixed, indexed records (shards/TFRecord/WebDataset/LMDB) that present tensors and metadata in the exact shapes and types the network expects; and/or (xxi) any combination thereof, any method of ingestion that is disclosed in papers that are incorporated herein by reference, and/or any other method that becomes apparent to one of skill in the art based on this disclosure.

Once the training data has been ingested in step 4010, a training methodology can be applied to generate the BAM in step 4012. Said training methodology includes a learning method and a loss function/reward. The learning methods may include: (i) supervised learning techniques (e.g., classification, regression, behavior cloning, etc.), (ii) unsupervised learning (e.g., clustering, dimensionality reduction, anomaly detection, etc.), (iii) transfer learning (e.g., by leveraging pre-trained models), (iv) reinforcement learning (e.g., model-free methods, model-based methods), (v) semi-supervised learning (e.g., training with labeled and unlabeled data), (vi) any combination thereof, and/or (vii) any method that is disclosed in papers that are incorporated herein by reference, and/or any other method that becomes apparent to one of skill in the art based on this disclosure.

After a general learning method is selected, the designer can then select a loss function or develop a reward function. Examples of loss functions that may be selected can include: (i) cross-entropy (with label smoothing) and BCE-with-logits, (ii) negative log-likelihood (token-level NLL, perplexity), (iii) focal loss and Hinge/Max-margin, (iv) regression losses (MSE/L2, MAE/L1, Huber/Smooth-L1, Charbonnier, Log-cosh), (v) segmentation/detection losses (Dice, IoU/Jaccard, Tversky/Focal-Tversky, Lovisz-Softmax; box L1/GIoU/DIoU/CIoU), (vi) metric/contrastive losses (Triplet, Contrastive, N-pair, Circle, Center; Cosine-similarity; ArcFace/AAM-Softmax, CosFace), (vii) self-supervised objectives (InfoNCE/NT-Xent, BYOL/Barlow Twins/DINO; masked-modeling MLM/MAE reconstruction), (viii) autoregressive maximum-likelihood (teacher-forcing NLL, sequence-level risk), (ix) VAE objectives (ELBO, β-VAE, KL annealing/free-bits), (x) GAN losses (non-saturating/logistic, Hinge, LS-GAN, WGAN-GP, Relativistic GAN), (xi) normalizing-flow likelihood (exact log-likelihood/bits-per-dim, FFJORD), (xii) diffusion/score matching (F-prediction MSE, v-param, xₒ-prediction, VLB, consistency/distillation), (xiii) audio/speech losses (STFT/multi-res STFT, spectral convergence, SI-SDR/SI-SNR with PIT, CTC, RNN-T), (xiv) 3D/geometry losses (Chamfer, EMD, point-to-surface, normal consistency, Eikonal/SDF, occupancy BCE), (xv) Perceptual/quality losses (feature/VGG, LPIPS, SSIM/MS-SSIM, total variation), (xvi) tokenizer/codebook losses (VQ commitment/codebook/EMA, Gumbel-Softmax straight-through), (xvii) distillation losses (temperature-scaled CE, KL to teacher, intermediate feature/attention transfer), (xviii) regularization terms (weight decay/L2, L1/Group-Lasso, dropout, spectral norm, orthogonality, gradient penalty, Jacobian/contractive, entropy/confidence penalties), (xix) RL policy losses (REINFORCE, PPO-Clip with value and entropy, TRPO, A2C/A3C), (xx) RL value/Q losses (TD error for DQN/Double-DQN, critic losses for DDPG/TD3, SAC entropy-regularized objective), (xxi) imitation learning losses (behavior cloning CE, GAIL discriminator, inverse RL), (xxii) any combination thereof, any method disclosed in papers that are incorporated herein by reference, or any method that becomes apparent to one of skill in the art based on this disclosure.

In a first example, the designer of an embodied AI system that outputs actions in a discretized action space (e.g., discrete bins) may use a cross-entropy loss function or a negative log-likelihood (NLL) function to measure the difference between the predicted probability distribution over the action bins and the true action. In another example, the designer of the BAM that outputs actions in a continuous space may use a regression-based loss function such as mean absolute error (MAE or L1 loss) or mean squared error (MSE or L2 loss).

Additionally/alternatively, the following list of reward functions may be utilized: (i) task success and progress (sparse success, dense shaping, time penalties), (ii) safety and constraints (collisions and limit violations), (iii) control costs (action L2, energy/torque use, smoothness/jerk penalties), (iv) environment/resource rewards (throughput, latency, energy/battery, cost/revenue, risk/CVaR), (v) exploration and intrinsic motivation (entropy bonus, novelty counts, curiosity/prediction error, empowerment, information gain), (vi) preference-based/human-feedback rewards (pairwise preference models, rule-based shaping), (vii) imitation-derived rewards (inverse RL, GAIL/AIRL discriminator scores), (viii) metric-based rewards for perception/NLP (BLEU/ROUGE/CIDEr, WER, F1, PSNR/SSIM), (ix) multi-objective composition (weighted sums, lexicographic ordering, constrained/Lagrangian optimization), (x) any combination thereof, and/or (xi) any method that is disclosed in papers that are incorporated herein by reference, and/or any other method that becomes apparent to one of skill in the art based on this disclosure.

As shown in FIG. 19, the designer can then use the selected training methodology in connection with the previously obtained/generated components of the BAM to generate said BAM. For example, the designer may utilize supervised learning in order to modify the internal parameters of components (e.g., both the alpha and beta models 3001.1, 3001.2) of the BAM in order to minimize the error between robot action predictions and the actual robot actions provided in the training data, thereby refining its ability to generate accurate and contextually relevant text and robot actions based on human commands, images, and other visual cues. Specifically, to train both the alpha model 3001.1 and the beta model 3001.2 end-to-end (e.g., from input of the alpha model 3001.1, through the latent vector, and to the output of the beta model 3001.2), a batch of ingested training data undergoes sampling from the preprocessed training dataset 4002 and feeds to said alpha and beta models 3001.1, 3001.2 at different frequencies. The observation or “data set” 4006, derived from the training data, may include a sequence of historical video frames, other sensor data, and the robot's state. The action or “desired action” 4008, also from the training data, may be represented by an action chunk, which comprises a sequence of target actions for the robot that extends over a future time horizon. The observation data from the batch undergoes ingestion by the network, and the resulting observations are used by the BAM to predict an output action chunk. In various embodiments, observation data may be time-aligned to the action chunk using timestamps and interpolation, sensor inputs may be normalized to a fixed scale, and missing fields may be masked so that the BAM conditions on valid channels. The alpha model 3001.1 may provide a latent vector that captures visual token embeddings, task text tokens, and state features, and the beta model 3001.2 may incorporate this latent vector through cross-attention to produce control trajectories. The models may process sequences with positional encodings, a defined context length, and a control rate that matches the robot controller update period, so that each element of the action chunk maps to a specific future step on the horizon.

The selected loss function can then be used to calculate the loss between the action chunk output by the beta model 3001.2 and the expert action chunk from the demonstration data/ground truth action. This calculated loss undergoes backpropagation through the network. Specifically, the gradients descend from the beta model 3001.2 output back to the beta model 3001.2 transformer network and then through the latent vector connection into the alpha model 3001.1. An optimization algorithm, such as Adam, updates the network weights to reduce the error. This training loop continues until a convergence criterion becomes met, such as the training loss plateauing or after a predetermined number of epochs. The output of this process comprises a trained model capable of generating action chunks based on visual inputs.

In certain embodiments, the loss may combine a regression term on joint targets or task-space poses with a temporal smoothness penalty across the action chunk, and may include a consistency term that aligns beta outputs with alpha-derived latent plans. The system may apply gradient clipping, weight decay, and a learning-rate schedule with warmup and cosine decay, and may use mixed precision for throughput. Convergence may be assessed on a validation split using sequence-level metrics such as horizon-integrated error, collision flags computed by a kinematic model, and satisfaction of joint and velocity limits. Batch size, horizon length, and update frequency may be selected to balance memory use and model stability on long sequences.

In addition to supervised learning, unsupervised learning techniques can be employed to further enhance the BAM. These techniques do not rely on actual robot actions provided in the training data but instead focus on identifying patterns and structures within the data itself. For example, the model can be trained using unsupervised methods such as clustering or self-supervised learning, where the model learns to group: (i) similar human commands together, (ii) similar visual and textual features together, and (iii) predict missing parts of robot actions, images, or text. For example, teleop data may be collected for a subset of the waypoints for a given task or movement. The unsupervised learning techniques can then determine the missing waypoints for the given tasks or movements. This helps the model develop a deeper understanding of the underlying relationships between robot actions, visual, and textual information, making the model more robust and adaptable to new, unseen data. In one approach, masked sequence modeling may be used over video tokens, state sequences, and action tokens so that the model reconstructs withheld segments, and contrastive objectives may align command text with visual clips and state descriptors. Latent dynamics models may predict future state embeddings from observations, which may improve action inference when labels are sparse.

Transfer learning represents another method used to train the BAM. In this approach, the model first undergoes pre-training on a large, general-purpose dataset and then undergoes fine-tuning on a smaller, domain-specific dataset. This allows the model to leverage the knowledge that the model has already acquired during pre-training and apply such knowledge to more specialized tasks, significantly reducing the amount of data and computational resources for training. Reinforcement learning can also be applied to fine-tune or train the BAM, particularly in scenarios where the model needs to interact with its environment and receive feedback on its performance. In this method, the model undergoes training to make decisions based on inputs, with the goal of maximizing a reward signal. This can involve methods like Q-learning, which learns the value of taking actions in particular states, or policy gradient methods like proximal policy optimization (PPO), which directly optimize the policy's parameters. A hybrid approach, reinforcement learning from human feedback (RLHF), can also be used, where human preferences shape the reward function, guiding the model towards more desirable behaviors without needing a manually specified reward function. Over time, the model learns to generate robot actions that not only accurately move the robot to the desired position, but also minimize the cost (e.g., battery, avoid singularities, etc.) in moving to the desired position. Finally, semi-supervised learning techniques can be utilized to fine-tune or train the BAM when only a limited amount of actual robot actions remains available. In this approach, the BAM undergoes training on a combination of actual robot actions and unlabeled input data, allowing the model to learn from the labeled actual robot action while also extracting useful information from the unlabeled input data. This method can improve the model's generalization capabilities and reduce the reliance on large, annotated datasets, making the model more efficient and scalable. In various embodiments, the reward may include penalties for torque, jerk, and proximity to joint limits, along with task completion bonuses and safety margins based on distance fields. On-policy rollouts may occur in simulation with domain randomization over textures, lighting, mass, and friction, and off-policy updates may draw from a replay buffer seeded with teleop trajectories. Human feedback for RLHF may be gathered as pairwise preferences over short clips of behavior, with an aggregation process that yields a learned reward model used to fine-tune the policy. Additionally, the designer may freeze certain layers, features, portions, or models during the training. For example, the designer may freeze the alpha model after a predefined time/number of training cycles, while they continue to train the beta model. Likewise, the designer may freeze the beta model after a predefined time/number of training cycles, while continuing to train the alpha model.

Following the initial training, the BAM may undergo an iterative process of testing and evaluation to validate and improve its performance. The BAM may be deployed on a physical or simulated humanoid robot, which undergoes monitoring as the robot attempts to perform a manipulation task autonomously. If the task performs successfully, the BAM becomes considered validated for the encountered states. If the robot fails to complete the task, a process for collecting corrective demonstrations may be initiated. In this process, an operator may take control of the robot from the failure state and provide a new, expert demonstration showing the correct sequence of actions to recover and complete the task. This new corrective demonstration then adds to the original training dataset, and the model undergoes retraining on this enriched dataset. This iterative loop of testing, collecting corrective data from failure states, and retraining allows the BAM to be progressively improved, making the model more robust and capable of handling a wider range of situations. Evaluation may track success rate, path efficiency, contact forces, and time to completion, and logs may include synchronized video, proprioception, and controller signals for audit and replay. The system may stage deployments from simulation to a lab mockup and then to target environments, with versioned BAM artifacts and rollback plans, and dataset aggregation may bias sampling toward states that produced prior errors to speed correction.

Following the above validation process, the BAM can be further refined through an optional fine-tuning process. Optionally, one or more features of the received training data 4002 may be modified, for example, by using a simulation engine to alter backgrounds, objects, or environmental characteristics in the training images. The BAM can be iteratively trained using this modified data. This iterative training can involve a variety of fine-tuning strategies to adapt the general-purpose pretrained model to specific tasks, environments, or embodiments. In one configuration, the simulation engine may vary camera pose, lens parameters, illumination, object placement, textures, and physics coefficients within set ranges to generate domain-randomized scenes, while preserving action labels through pose retargeting. Data augmentation may include geometric transforms, cutout masks, and text paraphrases of commands, and the system may rebalance class frequency to expose the BAM to rare states. Sensor calibration and time offset correction may be applied so that observation 4006 aligns with desired action 4008 across all synthetic and real sequences.

One effective strategy for finetuning involves co-finetuning, where the model undergoes training on a mixture of its original, large-scale pretraining data (e.g., internet-scale image and text data) and the smaller, domain-specific robotics dataset. This approach may help prevent catastrophic forgetting, where the model loses its general knowledge while specializing on the new data, thereby enhancing its ability to generalize to novel situations. For large models, full fine-tuning can be computationally prohibitive. In such cases, parameter-efficient fine-tuning (PEFT) methods may be employed. Techniques such as low-rank adaptation (LoRA) introduce a small number of trainable parameters in the form of low-rank matrices into the model, allowing for efficient adaptation without updating the entire set of original model weights. Other efficiency-focused techniques include model quantization, which reduces the precision of the model's weights to decrease its memory footprint and accelerate inference speed. Mixture sampling for co-finetuning may use a fixed ratio or a curriculum that increases the share of domain data over time, and replay of pretraining examples may be chosen by similarity to current tasks. LoRA ranks may be set per layer and targeted to attention and feedforward blocks, while the base weights remain frozen so that deployment footprint stays stable. Quantization may use per-channel scaling with 8-bit or 4-bit weights and calibrated activation ranges, and knowledge distillation from a larger teacher may align logits or intermediate features.

This optional iterative fine-tuning process can also be used to teach the BAM to generalize tasks and actions. For instance, a model initially trained to pick up a cup can be further trained on a diverse set of objects to learn a general “pick up” skill applicable to objects that the model has never seen before. This may involve training on a task-oriented subset of data or using corrective demonstrations collected from task failures to progressively improve the BAM. Finally, the fine-tuned BAM can be returned, ready for deployment on a humanoid robot. In various embodiments, skills may be encoded as goal-conditioned policies that accept object descriptors, pose targets, or language goals, and the action chunk may incorporate gripper control, force setpoints, and end-effector velocities. The deployment artifact may include the BAM, configuration files, normalization statistics for observation 4006 and desired action 4008, safety envelopes based on reachable workspace and load limits, and interface shims for common robot controllers, so that integration with existing control stacks proceeds with consistent reference numbers and terminology.

b. Deployment of Trained Model

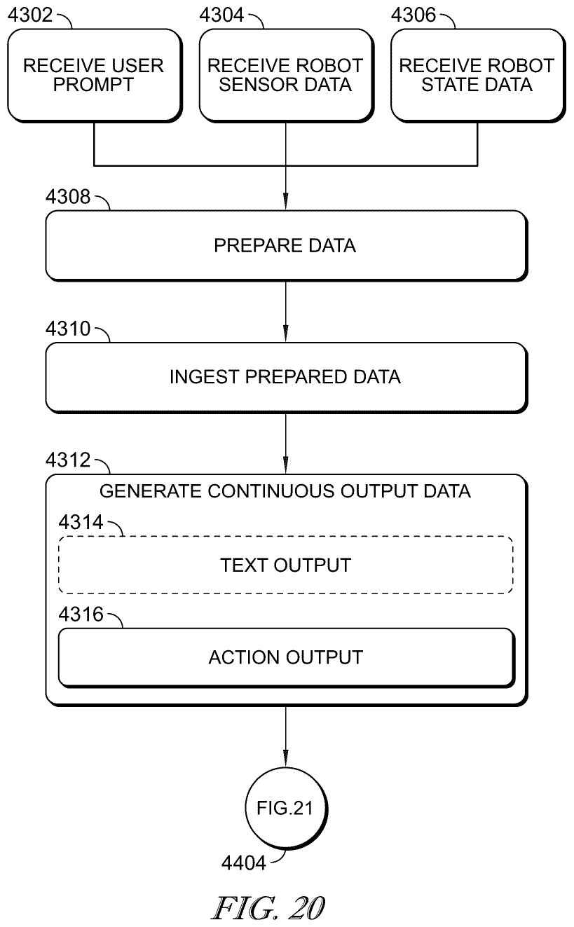

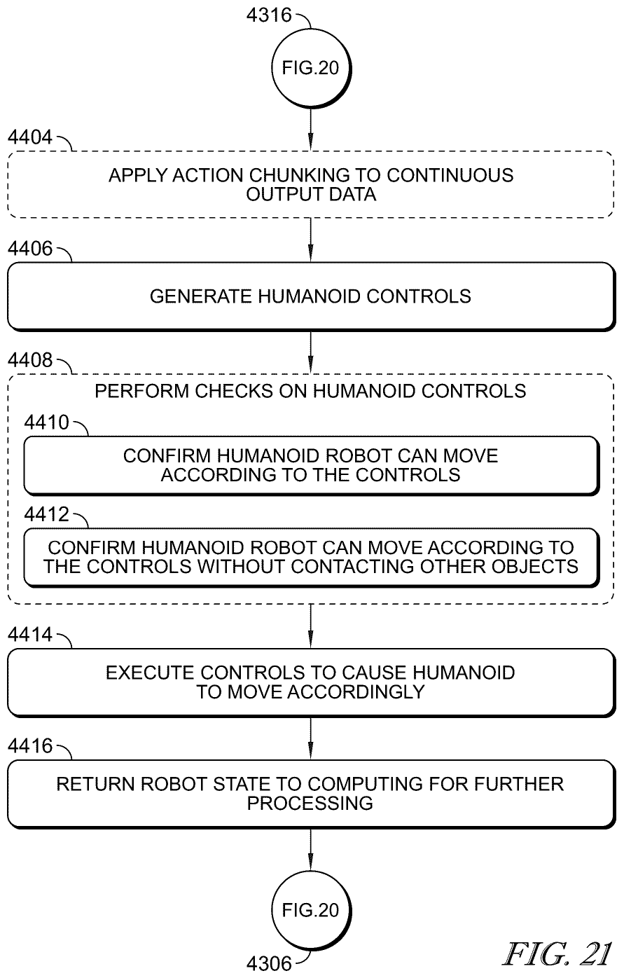

FIGS. 20-21 show flowcharts of a robot action-determining process for generating humanoid controls using a trained BAM during its runtime operation. This process functions as a continuous, closed-loop system that may be performed to determine and provide an initial position or rotational change for the humanoid robot, and then iteratively feed the robot's subsequent state back into the BAM along with additional robot sensor data and prompt data to determine the next sequence of actions. At the start of each cycle in the process, the robot 1, 2700A-X receives multiple streams of data. For example, said robot 1, 2700A-X may receive a user prompt (as shown in block 4302 of FIG. 20), which can be a high-level task, such as a spoken or natural language command from a human operator. Simultaneously, the robot may receive a stream of robot sensor data (as shown in block 4304 of FIG. 20) from the robot's various onboard sensors 1.2.8, such as cameras and IMUs, providing a real-time perception of the external environment. In addition to the generation or obtaining the prompt and sensor data, the robot 1, 2700A-X also generates robot state data (as shown in block 4306 of FIG. 20), which may include detailed proprioceptive information about the robot's current physical configuration, such as joint angles and end-effector positions, and may also include historical state data from previous timesteps.

At step 4308, the diverse, multimodal data can be prepared using any aspect of the above-described methods for preparing the training data. After the data undergoes preparation, the data can be ingested by the BAM at step 4310. Said ingestion of the data may include any aspect of the above-described methods for ingesting the training data. In an example, text-based prompts can be converted into a sequence of language embeddings, while visual data from the robot's cameras may be processed through a vision model, such as a CNN or ViT, to generate a corresponding set of image embeddings. Similarly, the robot's numerical state data can also be encoded into a vector representation, e.g., by an MLP. The BAM may then employ sophisticated mechanisms, such as cross-attention, to align and fuse these different token streams, enabling the BAM to effectively understand and react to the complex relationships between the linguistic command, the visual scene, and the robot's physical state.

Upon ingesting and processing the input data, the BAM generates continuous output data (as shown in block 4312 of FIG. 20). This continuous output data may be multifaceted and may include text data (as shown in block 4314 of FIG. 20), which could be transformed into a spoken response to the user for clarification or confirmation, and/or a detailed action output (as shown in block 4316 of FIG. 20), which contains the motor commands for the robot. The motor commands may include: (i) position information (e.g., position of each Degree of Freedom (DoF) in a 62 DoF system—X, Y, Z), (ii) location(s), (e.g., action space location for each of the 62 DoFs), (iii) actuator or motor current(s) (e.g., current for each actuator or motor that controls an extent of the 62 DoFs), (iv) actuator or motor torque(s) (e.g., torque for each actuator or motor that controls an extent of the 62 DoFs), (v) actuator encoder value(s) (e.g., encoder value for each actuator or motor that controls an extent of the 62 DoFs), (vi) changes in position information (e.g., changes for each of the 62 DoFs—ΔX, ΔY, ΔZ), (vii) changes in location(s) (e.g., changes in the action space locations for each of the 62 DoFs), (viii) changes in actuator or motor current(s) (e.g., changes in current for each actuator or motor that controls an extent of the 62 DoFs), (ix) changes in actuator or motor torque(s) (e.g., changes in torque for each actuator or motor that controls an extent of the 62 DoFs), (x) changes in actuator encoder value(s) (e.g., changes in encoder value for each actuator or motor that controls an extent of the 62 DoFs), (xi) rotational position information (e.g., rotational position of 62 DoFs—A°, B°, C°), (xii) rotational location(s) (e.g., action space rotational locations for each of the 62 DoFs), (xiii) changes in rotational position information (e.g., position of each of the 62 DoFs—ΔA°, ΔB°, ΔC°), (xiv) changes in rotational location(s) (e.g., changes in rotational action space locations for 62 DoFs), (xv) any combination of the above, or (xvi) any value or metric that becomes apparent to one of skill in the art based on the above disclosure. In other words, the BAM(s) can: (i) receive: (a) input data from a human user (e.g., speech), (b) sensor data from the robot, (c) state data (e.g., proprioception); (ii) process the received data; and (iii) output: (a) speech, and/or (b) actions or positional changes for the robot 1, 2700A-X to move to in order to accomplish the given task.

the outputs may be any numerical value, including any floating-point number that remains negative or positive. Further, the BAM may be modified to output any number of arrays, wherein each array can be used to control a DoF. For example, if the BAM includes 62 arrays for the 62 DoF of the robot, and each array includes 6 values; then said BAM creates 372 values. In other embodiments, the BAM may only generate 1 array that includes 7 values. Further, the BAM may generate fewer than 15 arrays that can control 62 DoF, wherein the WBC 1550 can generate the missing values. For example, the robot may not need the position and rotation of J3 or J5 from the BAM, if the BAM has provided J1, J2, J4, and J6. In other words, the number of arrays that are populated by the BAM's outputs may be less than the total number of DoF contained in the robot 1, 2700A-X, while the BAM remains able to control the robot 1, 2700A-X.

Optionally, this continuous output may be further processed by applying an action chunking algorithm (as shown in block 4404 of FIG. 21). This technique groups the continuous output into a sequence of actions that span a future time horizon, which helps to ensure that the robot's resulting movements remain smooth, coherent, and temporally consistent.

At step 4406, a set of low-level humanoid controls undergoes generation based on the continuous output or processed action chunk. This translation from high-level actions to low-level motor commands may be handled by the whole body controller 1550, which can apply sophisticated waypoint algorithms, cost functions, and kinematic constraints, such as joint limitations, to ensure that the robot moves in a manner that remains both efficient and physically plausible. In other embodiments, the above step that may be performed by the whole body controller 1550 may be omitted, and the BAM may directly output the low-level humanoid controls.

Before these controls are sent to the robot's hardware, the controller may also perform a series of rigorous safety checks on the generated controls (as shown in block 4408 of FIG. 21). These optional checks validate the feasibility and stability of the planned movements. This includes confirming that the robot remains physically capable of moving according to the specified controls without exceeding its joint limits or kinematic constraints (as shown in block 4410 of FIG. 21), and also verifying that the planned trajectory will not result in a collision with other objects in the environment or with the robot's own body (as shown in block 4412 of FIG. 21). If any of these checks fail, an error can be signaled, and the entire action-determining process may be repeated with updated sensor data to generate a new, stable, and valid plan.

Once the generated humanoid controls have been thoroughly validated, they are executed to cause the robot to move accordingly (as shown in block 4414 of FIG. 21). This final step involves converting the validated controls into precise electrical signals that are sent to the robot's actuators, thereby producing the desired physical movements. As the robot performs the current action, its new state, along with fresh sensor data from its environment, undergoes continuous capture and returns to the computing system for further processing (as shown in block 4416 of FIG. 21). This information then feeds back into the start of the control loop (as shown in block 4306 of FIG. 20), initiating the next cycle of the action-determining process. This iterative, closed-loop process of receiving multimodal inputs, determining the next best action, and executing the corresponding controls allows the robot to seamlessly perform complex, long-horizon tasks while dynamically adapting its movements in real-time in response to changes in its environment or unexpected events.

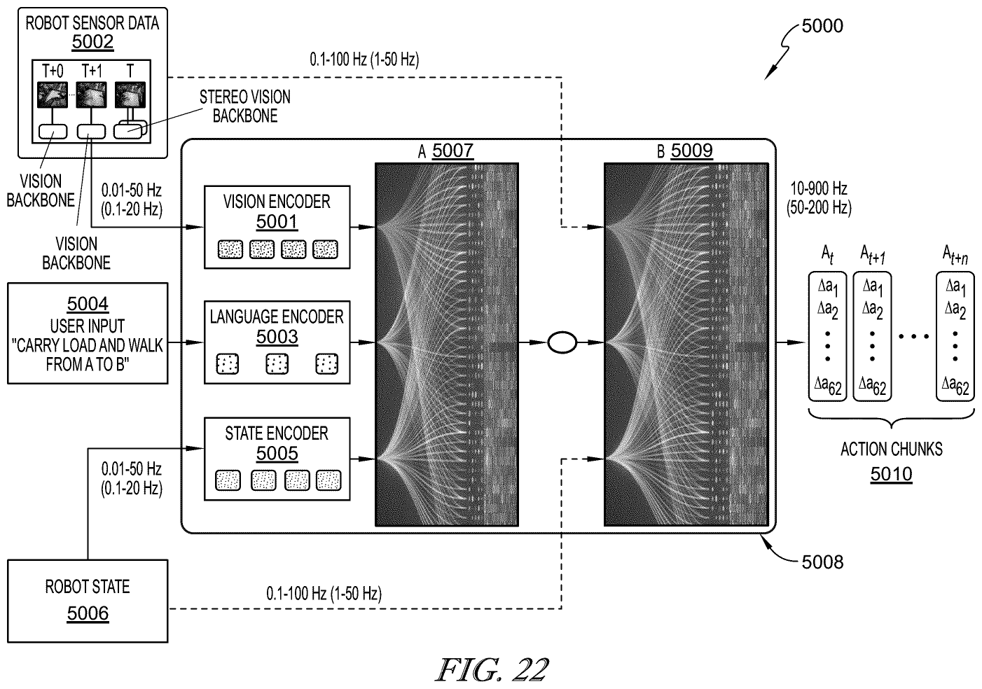

FIG. 22 illustrates a deployed BAM 5008 at runtime. The hierarchy of the BAM 5008 comprises two layers, a beta model 5009 at the bottom layer and a pretrained alpha model 5007 at the top layer, similar to the architecture 3060 shown in FIG. 16A. The top layer alpha model 5007 may have a larger number of parameters (e.g., billions of parameters) and consequently requires more processing time and power relative to the lower-level beta model, which may be of a size of millions of parameters. Furthermore, the higher-layer alpha model 5007, as shown in FIG. 22, runs at a much lower frequency (e.g., 0.1-20 Hz) for reasoning and planning, while the beta 5009 runs at much higher frequency of 50-200 Hz for real-time robot action control.

The system 5000 continuously receives multimodal inputs from its environment and a human user. Robot sensor data 5002, which may include a history of recent image frames from various onboard cameras, undergoes processing by a vision encoder 5001 to generate a sequence of vision tokens. Concurrently, a user input 5004, such as a natural language command like “carry load and walk from A to B,” undergoes processing by a language encoder 5003. The robot's current proprioceptive state 5006, including joint angles and end-effector poses, undergoes processing by a state encoder 5005. These three streams of encoded information then feed into the deployed bipedal action model 5008. The model's output comprises a series of parallel-generated action chunks 5010, which includes Aₜ to Aₜ₊ₖ, representing a sequence of future actions. For example, an action Aₜ may be a matrix (Δa₁, . . . , Δa₃₅), where each row Δaᵢ corresponds to the desired change for a specific degree of freedom of the robot, such as a vector representing changes in position and orientation (δx, δy, δz, δθₓ, δθ_{y}, δθ_{z}) for a joint. The full matrix Aₜ may have a row dimension of 62, corresponding to all 62 degrees of freedom of the robot. If the beta model receives a task to output an action chunk for a subset of the robot's body, such as the upper body, then the action vector Aₜ may be a matrix with fewer rows. This sequence of chunks may cover a short future time horizon, for example, the next 10 to 500 milliseconds (preferably 50 to 150), and can be sent to the robot's low-level controllers for execution.

Action chunking represents a technique where a beta model predicts and executes a sequence of multiple future actions in a single inference step, rather than generating one action at a time. In the context of vision-language-action (VLA) models, a beta model can make a single, complex decision to predict a sequence, or “chunk,” of k future actions. This chunk typically represents the target robot states (e.g., joint positions), or changes from current states for the next k timesteps. The robot then executes this sequence of actions, either fully or partially, before the beta model undergoes querying again for the next chunk. This method reframes the learning problem from low-level mimicry to high-level trajectory generation, which proves well-suited for sequence modeling architectures like the transformer.

The use of action chunking may provide several key benefits for robotic control. A primary advantage involves the mitigation of compounding errors, a common problem in imitation learning where small prediction errors accumulate over time, causing the robot to deviate from the desired trajectory. By predicting a sequence of k actions at once, the BAM makes k times fewer independent decisions, which reduces the opportunities for errors to compound and shortens the effective horizon of the task. Action chunking can also help handle non-Markovian behaviors often present in human demonstration data, such as pauses, by allowing the BAM to implicitly model temporal information within the action sequence. Furthermore, action chunking can enable high-frequency robot control with low-frequency inference from large, computationally intensive models. The BAM can operate at a reduced frequency and at each step output a chunk of actions, while a low-level controller can execute at a much higher frequency to ensure smooth and stable motion. Action chunking may also introduce a trade-off between temporal consistency and short-term reactivity. Longer action chunks result in smoother, more consistent motion but make the system less responsive to unexpected environmental changes. Conversely, shorter action chunks allow for more frequent replanning and greater reactivity, but can increase the risk of compounding errors. The optimal chunk size, therefore, may depend on both the specific task and the latency of the model, thus requiring careful adjustments to achieve the desired balance between smoothness and responsiveness.

### F. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/319,712; and (iii) U.S. Design patent application Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A system for generating commands for a humanoid robot, comprising:
a bipedal action model that includes:
an alpha model configured to generate contextual embeddings at a first frequency based on visual observations and language instructions, and wherein the alpha model comprises a vision-language model with more than 1 billion parameters;
a beta model: (i) configured to generate a set of continuous values based in part upon the contextual embeddings from the alpha model, (ii) operating at a second operational frequency that is higher than the first operational frequency, and (iii) includes fewer parameters than the alpha model.

2-3. (canceled)

4. The system of claim 1, wherein the alpha model is deployed on a remote server and the beta model is deployed on local processors integrated within the robot.

5-8. (canceled)

9. The system of claim 1, wherein the alpha model operates at between 1 μHz to 10 hz and includes between 5 billion and 2 trillion parameters, and the beta model operates at between 1 hz to 10 kHz and includes between 10,000 and 5 billion parameters.

10-18. (canceled)

19. The system of claim 1, wherein the set of continuous values comprise at least 30 values, and wherein each value is associated with at least one degree of freedom.

20. The system of claim 1, further comprising an action chunk that includes: (i) the set of continuous values, and (ii) other sets of continuous values, and wherein the set and other sets of continuous values are sequenced over a predetermined time horizon, and wherein the action chunk is generated in a single inference step.

21. The system of claim 1, wherein the alpha model is a vision-language model that has been pre-trained on data from the internet.

22. The system of claim 21, wherein the bipedal action model includes a single beta model with a single set of neural network weights that are configured to allow the humanoid robot to perform a plurality of dexterous whole body behaviors without using a second set of neural network weights.

23. The system of claim 22, wherein the bipedal action model alpha and beta models are post-trained, end-to-end using a loss function with gradients propagated back up to the alpha model.

24. The system of claim 23, wherein the post-trained process uses high-quality demonstrations that have been automatically labeled in part by another separate and distinct transformer-based model.

25. The system of claim 1, wherein the bipedal action model further integrates a Retrieval-Augmented Generation module to obtain real-time knowledge retrieval from external sources.
